(19) United States
(12) Patent Application Publication
(10) Pub. No.: US 2023/0124125 A1
(43) Pub. Date: Apr. 20, 2023

(54) PROTECTED PLANTS AND METHODS OF OBTAINING THEM

(71) Applicant: THE STATE OF ISRAEL MINISTRY OF AGRICULTURE AND RURAL DEVELOPMENT AGRICULTURAL RESEARCH ORGANIZATION, Rishon Lezion (IL)

(72) Inventor: Elena POVERENOV, Nes Ziona (IL)

(21) Appl. No.: 17/906,390

(22) PCT Filed: Mar. 17, 2021
(86) PCT No.: PCT/IL2021/050293

§ 371 Date: Sep. 15, 2022

Related U.S. Application Data
(60) Provisional application No. 62/990,763, filed on Mar. 17, 2020.

(51) Int. Cl. A01N 25/10; A01P 3/00; C09D 101/28; C09D 105/08; A01N 65/00

(52) U.S. Cl. CPC A01N 25/10; A01P 3/00; C09D 101/286; C09D 105/08; A01N 65/00

(57) ABSTRACT

The present disclosure provides a plant comprising a skin-like composition, wherein the skin-like composition is a carrier matrix in a form of a continuous layer covering at least one surface of the plant, wherein the layer permits at least gas exchange therethrough; and wherein at least part of the plant is capable of undergoing vegetative reproduction, a nursery comprising plurality of the plants and methods of treating plants.

### TECHNOLOGICAL FIELD

The present disclosure relates to agriculture and specifically to plant protection.

### BACKGROUND ART

References considered to be relevant as background to the presently disclosed subject matter are listed below:
[1] Huijser, P., Schmid M. The control of developmental phase transitions in plants. Development, 138, (2011) 4117
[2] Precise agriculture. https://precisionagricultu.re/tips-for-early-crop-protection
[3] U.S. Pat. No. 5,251,398
[4] Yage X., Qinglian X., Chitosan-based coating with antimicrobial agents: preparation, property, mechanism, and application effectiveness on fruits and vegetables. Hindawi Publishing Corporation (2016).
[5] Bonham M., Ghidiu G. M., Hitchner E. and Rossell E. L. Preharvest Lipophilic Coatings Reduce Lenticel Breakdown Disorder in ‘Gala’ Apples. Horttechnology, 19 (2009) 617-619.
[6] Zeng D., Shi Y. Preparation and application of a novel environmentally friendly organic seed coating for rice. J Sci Food Agric., 89 (2009) 2181-2185.
[7] International Patent Application No. WO19186533.
[8] International Patent Application No. WO1999057959.
[9] Xinrong L., Renjie T., Application of bioactive coating based on chitosan for soybean seed protection. Hindawi Publishing Corporation (2012).
[10] US Patent Application No. US20140100111.

Acknowledgement of the above references herein is not to be inferred as meaning that these are in any way relevant to the patentability of the presently disclosed subject matter.

### BACKGROUND

Environmental factors such as heat, cold, UV and humidity along with microorganisms (bacterial fungal and viruses) contamination and harmful insects cause injury to the plants and economic damages [1]. The existing anti-insects, antimicrobial agent and other protective agents (either synthetic or nature-sourced compounds) are problematic for use in early growth stage plants. In this stage the plants are very prone and an effective dose of active agent usually causes phytotoxicity. Therefore, for the early growth plants such as seedling, cuttings, sprouts, etc, either no protective treatment is done at all or treatment with very low (barely efficient does of protectant) is done [2]. Hence, there is an unsolved and urgent need for delivery of active agents to protect plants in their early growth stages, when the plants are very prone and gentle, and possibility to provide them with active agents without causing phytotoxic damage.

Defensive cover can be used for protection of plants and agricultural product from the outside damages. Synthetic polymer-based covers are used to enhance storability and quality of non-edible plants such as decorative trees [3]. Non-edible and edible coatings were reported to provide efficient prolongation of shelf-life and storability of fruits and vegetables. Such coatings based on biopolymers and synthetic polymers are usually applied after harvest, rarer preharvest, and allow less mass and water loss and less microbial contamination of fruits and vegetables. [4, 5] Active coatings of fruits and vegetables can also be combined with antimicrobial or other active agents [4]. Coatings of seeds, such as rice and corn, are also described in the art [6, 7, 8]. For instance, biodegradable seed coating compositions for enhancing seed protection based on hydrogel formulations comprising hydrophilic protein in combination with a polysaccharide are described [7]. The application process and formation of bioactive coating based on chitosan for soybean seeds protection has been described [9]. Plant seeds having a film coating made of polymers such as starch, was also described [10].

### SUMMARY OF INVENTION

The present disclosure provides, in accordance with a first of its aspects, a plant comprising a skin-like composition, wherein said skin-like composition is a carrier matrix in a form of a continuous layer covering at least one surface of said plant, wherein said layer permits at least gas exchange therethrough; and wherein at least part of said plant is capable of undergoing vegetative reproduction.

Also disclosed herein, in accordance with a second of its aspects, it is provided a nursery comprising a plurality of plants, each plant comprises a skin-like composition, wherein said skin-like composition is a carrier matrix in a form of a continuous layer covering at least one surface of said plant, wherein said layer permits at least gas exchange therethrough; and wherein at least part of said plant is capable of undergoing vegetative reproduction.

In accordance with a third aspect, the present disclosure provides a method for treating (including prophylactic treatment) a plant, said method comprises applying onto said plant an agriculture formulation in a manner forming on at least one surface of said plant or part thereof a continuous layer, wherein said agriculture formulation is or comprises a carrier matrix, the amount of said agriculture formulation applied on said at least one surface is such to permit at least gas exchange therethrough, wherein at least part of said plant is capable of undergoing vegetative reproduction.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIGS. 1A-1F are photos of alfalfa sprouts 1 day after treatment with various solutions, FIG. 1A treatment with a solution comprising 1.5% (w/v) aqueous solution of carboxymethyl cellulose that contain 0.1% (w/v) potassium sorbate; FIG. 1B treatment with a solution comprising 1.2% (w/v) aqueous solution of chitosan with 0.6% (w/v) acetic acid that contain 0.1% (w/v) potassium sorbate; FIG. 1C treatment with a solution comprising 1.5% (w/v) aqueous solution of carboxymethyl cellulose; FIG. 1D treatment with a solution comprising 1.2% (w/v) aqueous solution of chitosan with 0.6% (w/v) acetic acid; FIG. 1E treatment with a solution comprising 0.1% (w/v) potassium sorbate; FIG. 1F a control group, i.e., plant sprouts without any treatment.

FIGS. 2A-2F are photos of broccoli sprouts 1 day after treatment with various solutions, FIG. 2A treatment with a solution comprising 1.5% (w/v) aqueous solution of carboxymethyl cellulose that contain 0.1% (w/v) potassium sorbate; FIG. 2B treatment with a solution comprising 1.2% (w/v) aqueous solution of chitosan with 0.6% (w/v) acetic acid that contain 0.1% (w/v) potassium sorbate; FIG. 2C treatment with a solution comprising 1.5% (w/v) aqueous solution of carboxymethyl cellulose (CMC); FIG. 2D treatment with a solution comprising 1.2% (w/v) aqueous solution of chitosan with 0.6% (w/v) acetic acid; FIG. 2E treatment with a solution comprising 0.1% (w/v) potassium sorbate; FIG. 2F control group—plant sprouts without any treatment.

FIGS. 3A-3B are bar graphs showing reduction of microbial content (total aerobic counts on Plate Count Agar (PCA) medium) of broccoli (FIG. 3A) and alfalfa (FIG. 3B) by different treatments (1) 0.1% (w/v) potassium sorbate; (2) 1.5% (w/v) aqueous solution of CMC that contain 0.1% (w/v) potassium sorbate; (3) 1.2% (w/v) aqueous solution of chitosan with 0.6% acetic acid that contain 0.1% potassium sorbate; (4) 1.5% (w/v) aqueous solution of CMC; (5) 1.2% (w/v) aqueous solution of chitosan with 0.6% (w/v) acetic acid in comparison to control, each value indicates the means of 4 duplicate tests, error bars represent 95% confidence interval.

FIGS. 4A-4B are bar graphs showing reduction of microbial content (yeast and mold counts on Potato Dextrose agar (PDA)+A medium) of broccoli (FIG. 4A) and alfalfa (FIG. 4B) by different treatments (1) 0.1% potassium sorbate; (2) 1.5% aqueous solution of CMC that contain 0.1% potassium sorbate; (3) 1.2% aqueous solution of chitosan with 0.6% acetic acid that contain 0.1% potassium sorbate; (4) 1.5% aqueous solution of CMC; (5) 1.2% aqueous solution of chitosan with 0.6% acetic acid in comparison to control, each value indicates the means of 4 duplicate tests, error bars represent 95% confidence interval.

FIGS. 5A-5F are photos of petri dishes with alfalfa after different treatments: FIG. 5A potassium sorbate; FIG. 5B CMC, 1.5%; FIG. 5C Chitosan, 1.2%; FIG. 5D potassium sorbate and Chitosan, 1.2%; FIG. 5E potassium sorbate and CMC, 1.5%; FIG. 5F control

FIGS. 6A-6F are photos of petri dishes with broccoli after different treatments: FIG. 6A CMC; FIG. 6B CMC, 1.5%; FIG. 6C Chitosan, 1.2%; FIG. 6D potassium sorbate and Chitosan, 1.2%; FIG. 6E potassium sorbate and CMC, 1.5%; FIG. 6F control.

FIGS. 7A-7F are photos of purple broccoli seedlings 7 days after treatment at optimal conditions (3 days) followed by sub-optimal conditions (4 days); FIG. 7A treatment with CMC; FIG. 7B treatment with CMC and potassium sorbate; FIG. 7C treatment with chitosan; FIG. 7D treatment with chitosan and potassium sorbate; FIG. 7E treatment with potassium sorbate; FIG. 7F without any treatments (control group).

FIGS. 8A-8L are photos of treated and untreated tomato seedlings after 7 days at optimal conditions as defined in Table 2.

FIGS. 9A-9B are photos of water contact angle of Chitosan (FIG. 9A) and Chitosan-Tea Tree Oil (TTO) (FIG. 9B) based coatings.

FIGS. 10A-10E are photos of mint, salvia and rosemary cuttings, from left to right, 7 days after treatment; FIG. 10A treatment with alginate 1% and Thymol 2%; FIG. 10B treatment with alginate 1% and Tea tree oil (TTO) 2%; FIG. 10C treatment with methyl cellulose (MC) 1% and Thymol 2%; FIG. 10D treatment with MC 1% and TTO 2%; FIG. 10E control, no treatment.

FIGS. 11A-11B are photos of treated salvia cuttings 17 days after being rooted, FIG. 11A cutting successfully rooted and grow after treatment with MC 1% and Thymol 2%; FIG. 11B cutting successfully rooted and grow after treatment with alginate 1% and Thymol 2%.

FIGS. 12A-12C are bar graphs showing pests content of different seedling plants 18 hours after treatment (spraying) with the following: (i) Echo-tech 0.1% (positive control), (ii) alginate 1% and Thymol 2%, (iii) MC 1% and Thymol 2%, (iv)Thymol 2%, (v) MC 1% and tea tree oil (TTO) 2%, (vi) alginate 1% and TTO 2%, (vii) TTO 2%, (viii) MC 1%, (ix) Alginate 1%, (x) water (control); FIG. 12A mint seedlings; FIG. 12B rosemary seedlings; FIG. 12C thyme seedlings.

FIGS. 13A-13F are photos showing the effect of the carrier matrix in avoiding phytotoxic effects of thymol, FIG. 13A rosemary plant treated with Thymol; FIG. 13B thyme plant treated with Thymol; FIG. 13C mint plant treated with Thymol; FIG. 13D rosemary plant treated with Alginate and Thymol; FIG. 13E thyme plant treated with Alginate and Thymol; FIG. 13F mint plant treated with Alginate and Thymol.

FIGS. 14A-14F are microscope images of different carrier-matrix compositions, FIG. 14A Alginate 1% and TTO 2%; FIG. 14B MC 1% and TTO 2%; FIG. 14C Alginate 1% and Thymol 2%; FIG. 14D MC 1% and Thymol 2%; FIG. 14E TTO 2%; FIG. 14F Thymol 2%.

FIGS. 15A-15B are graphs showing the release of thymol from carrier-matrix based Alginate at different temperatures, FIG. 15A at 30° C.; FIG. 15B at 24° C.

FIGS. 16A-16F are photos of potato tuber under UV light after treatment with different carrier-matrix compositions labeled with fluorescent dye, FIG. 16A treatment with carrier-matrix based Alginate; FIG. 16B treatment with carrier-matrix based MC; FIG. 16C treatment with carrier-matrix based CMC; FIG. 16D treatment with carrier-matrix based CMC and stearic acid; FIG. 16E treatment with carrier-matrix based Chitosan; FIG. 16F no carrier-matrix treatment, control.

FIGS. 17A-17F are photos of thyme cuttings under UV light after treatment with different carrier-matrix compositions labeled with fluorescent dye, FIG. 17A treatment with carrier-matrix based Alginate; FIG. 17B treatment with carrier-matrix based MC; FIG. 17C treatment with carrier-matrix based CMC; FIG. 17D treatment with carrier-matrix based CMC and stearic acid; FIG. 17E treatment with carrier-matrix based Chitosan; FIG. 17F no carrier-matrix treatment, control.

### DETAILED DESCRIPTION

The present disclosure is based on the understanding that it is of the essence to protect plants from harmful organisms, microorganisms and environmental damages and the possibility to combine such protection with nutrients and biomolecules to be transferred to the growing (non-dormant) plant so as to support the plant's development, particularly at the early stages of growth.

Thus, in accordance with some aspects, it is provided a plant comprising a skin-like composition, wherein the skin-like composition (skin-like cover) is a carrier matrix in a form of a continuous layer covering at least one surface of the plant, wherein the layer permits at least gas exchange therethrough.

In some embodiments, at least part of the plant is capable of undergoing vegetative reproduction, i.e. being a vegetative reproductive material.

In some other embodiments, at least part of the plant is capable of undergoing photosynthesis.

In accordance with it's first aspect, the present disclosure provides, a plant comprising a skin-like composition, wherein the skin-like composition is a carrier matrix in a form of a continuous layer covering at least one surface of the plant, wherein the layer permits at least gas exchange therethrough; and wherein at least part of the plant is capable of undergoing vegetative reproduction.

In the following text, when referring to a plant it is to be understood as also referring to at least one plant, plurality of plants or a nursery or methods disclosed herein. Thus, whenever providing a feature with reference to the plant, it is to be understood as defining the same feature with respect to the nursery, and methods, mutatis mutandis.

As described herein, the continuous layer formed by the skin-like composition, has various advantages, some of which include: (i) the layer provides an elastic cover, allowing growth and/or development of the plant or any part thereof, (ii) permits gas exchange, enabling breathing of the plant or any part thereof (iii) acts as a “second skin” of at least part of the plant and protects the plant or any part thereof, from environmental conditions or damages, including, inter alia, UV, water loss, temperature fluctuations: chilling, heat, humidity, plant pests (e.g. bacterial fungal and viruses) or insects as well as covers wounds, optionally micro wounds that may attract plant pests (iv) reduce, prevent, protect the phytotoxic effect to the plant or any part thereof, possibly by an agent used in an attempt to protect the plant. As shown herein, the continuous cover layer was capable of maintaining functionality (e.g. provides protection) for a long time period, for example, at least 7 days and/or at non-optimal or sub-optimal growth conditions.

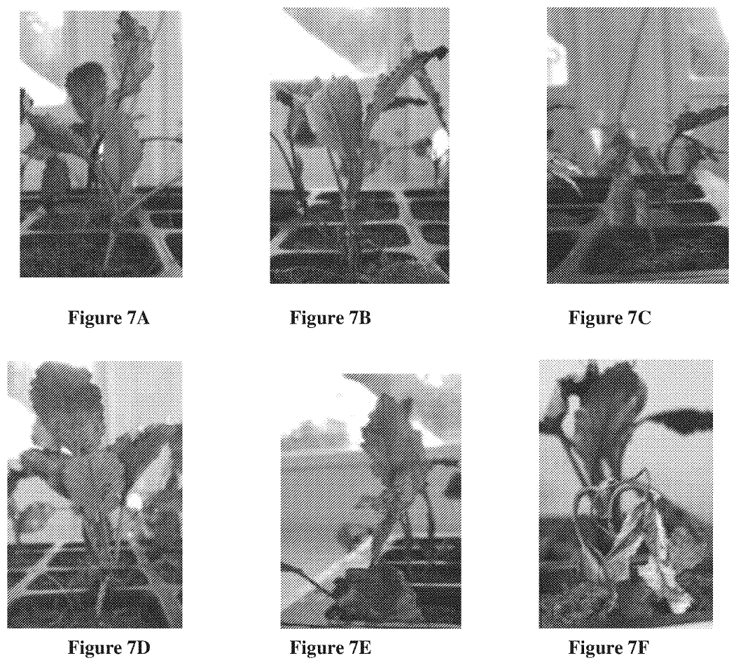

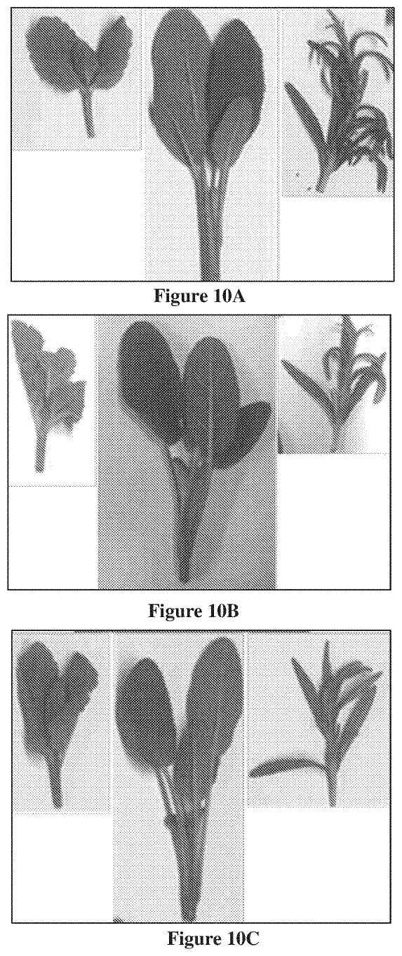

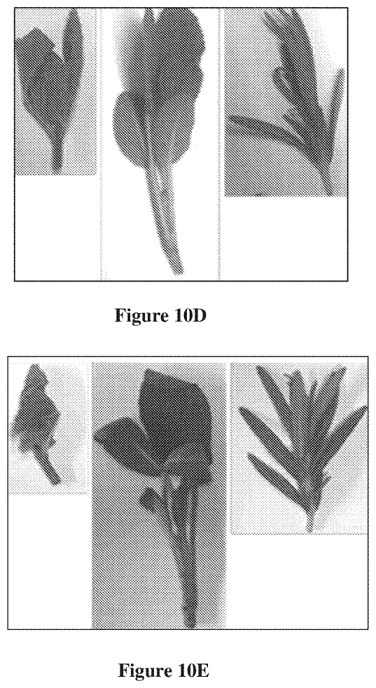

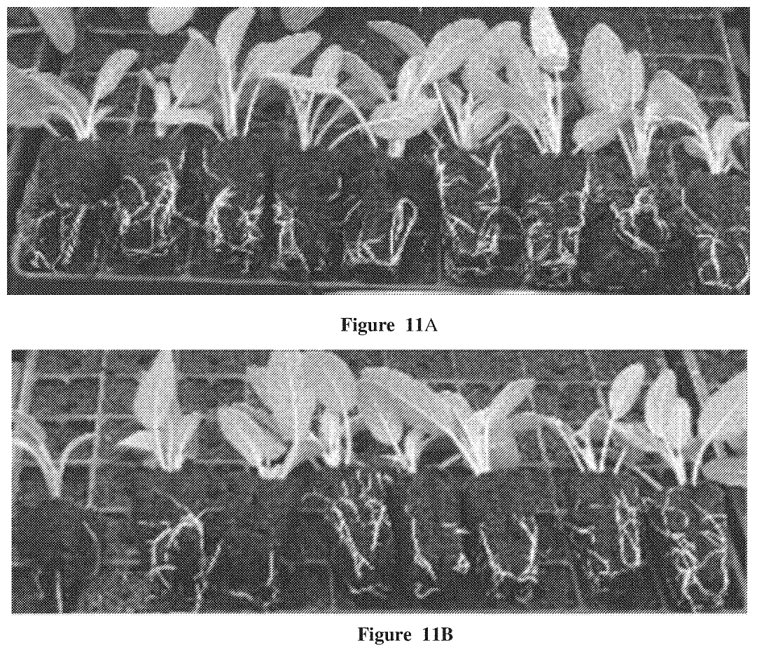

As shown in Example 4, (FIG. 7), the skin-like compositions of the invention protected purple broccoli plant seedlings from sub-optimal conditions (dark room and no watering). Further, as shown Example 8, (FIG. 10), mint cuttings, salvia cuttings and rosemary cuttings kept their quality after 7 days of storage, suggesting that the skin-like composition (skin-like cover) is useful in allowing storability. In addition, as shown in Example 8, (FIG. 11), the root system of sage plants after 17 days of growth in the presence of the skin-like compositions of the invention demonstrates a good rooting ability and proper plant development.

This suggested that the continuous layer is capable of protection at least part of the plant, at various sub-optimal growth conditions, including, inter alia, reduced light, and/or reduced water as well as allow storability. Further, this suggested that the skin-like composition permits growth of at least part of the plant being covered by the composition.

In the context of the present disclosure, the term “plant” is used herein to denote a plant as a whole or any part thereof.

In some embodiments, the plant is at an early growth stage.

In some embodiments, the plant or any part thereof is capable of undergoing photosynthesis.

In some embodiments, the plant or any part thereof is capable of undergoing vegetative reproduction.

It is of note that at least part of the plant can undergo vegetative reproduction at any time, for example, immediately after obtained from the plant or at later time.

Hence, in accordance with some examples, it is provided a vegetative reproductive material comprising a skin-like composition, wherein the skin-like composition is a carrier matrix in a form of a continuous layer covering at least one surface of the vegetative reproductive material, wherein the layer permits at least gas exchange therethrough.

Vegetative reproduction (also known as vegetative propagation, vegetative multiplication or cloning) refers to asexual reproduction occurring in plants, possible by use of meristem tissue.

Vegetative reproduction can occur naturally or be induced artificially.

Without being limited thereto, in the context of the present disclosure, the plant is in any of the following growing stages: stolons (tuberization), sprouts, seedling, rooting, vegetative, budding, flowering, ripening.

In some embodiments, the plant is in at least one growing stage. In some embodiments, the plant is in at least one of rooting stage, sprouting stage, seedling stage, vegetative stage, budding stage, flowering stage, ripening stage, reproductive stage, or senescence stage.

In some other embodiments, the plant is in a vegetative stage or a seedling stage.

In some further embodiments, the plant is in a seedling stage.

The plant as used herein exclude plants or plant parts at their dormant stages.

The plant can be any plant, and in accordance with some examples is a green plant.

In some examples, the plant is a preharvest plant in its early growth stages.

In some embodiments, the plant is a crop. Crop as used herein refers to cultivated plants products that can be grown and harvested as harvested parts or as a whole.

In some embodiments, the plant crop is at least one of a fruit plant, a vegetable plant, a herb plant, a cereal plant, or a flowering plant.

In some embodiments, the plant is an early growth plant.

In some embodiments, the plant is plant nursery (greenhouse).

In some embodiments, the plant is a flowering plant.

In some embodiments, the plant is at least one plant from the families of Angiosperms, Gymnosperms, Pteridophytes, Bryophytes, or any combination thereof.

In some other embodiments, the plant is a conifer, a cycad or an allies

In some further embodiments, the plant is ferns or fern allies. In some other embodiments, the plant is Mosses or liverworts.

In some examples, the plant is alfalfa. In some embodiments, the plant is petunia.

In some examples, the plant is from the Lamiaceae family. In some embodiments, the plant is a herb. In some embodiments, the plant is at least one of basil, Mentha, mint, rosemary, sage, savory, marjoram, oregano, hyssop, thyme, lavender, or perilla. In some examples, the plant is mint or rosemary.

In some embodiments, the plant is a vegetable plant. In some embodiments, the vegetable plant is from the Brassicaceae family. In some embodiments, the plant is at least one of cabbage plant, broccoli plant, purple broccoli plant, cauliflower plant, kale plant, Brussels sprouts plant, collard greens plant, Savoy plant, kohlrabi plant, gailan plant, turnip plant, napa cabbage plant, bomdong plant, bok choy plant, rapini plant, rocket salad plant, garden cress plant, watercress plant, radish plant, horseradish plant, Brassica plant, wasabi plant, white mustard plant, indian mustard plant or black mustard plant.

In some embodiments, the plant is broccoli plant or purple broccoli plant.

In some embodiments, the plant is a fruit plant. In some embodiments, the plant is at least one of tomato plant, plum plant, zucchini plant, melon plant, cucumber plant, pepper plant, watermelon plant, eggplant plant. In some examples, the plant is tomato plant.

In some embodiments, the plant is leafy plant. In some embodiments, the leafy plant is at least one of lettuce plant, spinach plant, leek plant, celery plant, endives plant, chards plant, kale plant, microgreen plant, collard greens plant, cabbage plant, beet greens plant, watercress plant, chard plant, arugula plant, endive plant, bok choy plant or turnip greens plant.

In some embodiments, the crop is an edible crop, i.e. used as a food crop.

In some embodiments, the plant is a seedling.

In some examples, the plant is a purple broccoli seedling, a tomato seedling, mint seedling, salvia seedling or rosemary seedling.

In some embodiments, the plant is a sprout.

In some examples, the plant or part thereof is an alfalfa sprout. In some examples, the plant part or part thereof is a broccoli sprout.

The plant as used herein and as detailed above encompasses any plant part.

In some embodiments, the plant part is at least one of runner, a bulb, a tuber, a corm, a sucker, a plantlet, a kiekies, an apomixis, a leaf, a root, a sprout, a stem, a cutting, a bud or combination thereof.

In some embodiments, the vegetative reproduction occurs naturally.

In some embodiments, the vegetative reproduction occurs artificially.

In some embodiments, the plant part is at least one of a stem, a sprout, a leaf, a root, a runner, a bulb, a tuber, a corm, a sucker, a plantlet, a kiekies or a apomixis.

In some embodiments, the plant part is at least one of roots, stems, buds, leaves or combination thereof.

In some other embodiment, the plant part is roots, sprouts or leaf.

In some embodiments, the plant part is a plant cutting. The plant cutting is typically cut of a plant to form the plant part as described herein. In some embodiments, cutting is at least one of a stem, a root, a leaf or a combination thereof. In some other embodiments, cutting is at least one of a stem, a leaf or a combination thereof.

In some embodiments, the plant part is a stem or a leaf.

It should be noted that the plant part does not encompasses a plant part which can not undergo vegetative reproduction, such as a fruit or a vegetable.

In some examples, the plant parts that are cut from the plant are “green” parts, leaf and/or steam.

In some embodiments, the plant part is roots.

In some embodiments, the plant part is a sprout.

In some embodiments, the plant part is a tuber. In some examples, the plant part is a potato tuber.

In some embodiments, the plant part is a cutting. In some examples, the cutting is a herb cutting. In some examples, the plant part is a mint cutting, a salvia cutting, a rosemary cutting, a thyme cutting.

In some examples, the cutting is a flowering plant cutting. In some examples, the cutting is a cutting of a petunia flower.

In some examples, there is thus disclosed a plant comprising a skin-like composition that forms on at least one surface of the plant, a cover, such as a continuous cover, at times in a form of a continuous layer. The layer is at time referred herein as functional cover.

Further disclosed, in accordance with some examples, is a vegetative reproductive material comprising a skin-like composition that forms on the vegetative reproductive material or part thereof a continuous layer.

In some examples, there is thus disclosed a seedling comprising a skin-like composition that forms on the seedling or part thereof a continuous layer. For example, when the plant is a seedling, the skin-like composition can be applied by smearing, spraying, bushing over the seedling or immersing the seedlings within to provide protection from excessive water loss, or from excessive chilling, excessive heat, or for protecting the seedling from insects including aphids.

In some other examples, there is disclosed a sprout comprising a skin-like composition that forms on the seedling or part thereof a continuous layer.

In some further examples, disclosed are cuttings comprising a skin-like composition that forms on the cutting or part thereof a continuous film. For example, when the plant is a cutting, the skin-like composition can be applied by smearing, spraying, bushing over the cuttings or immersing the cuttings within to provide protection from excessive water loss, or from excessive chilling, excessive heat, or for protecting the cuttings from harmful microorganisms or insects.

In yet some other examples, disclosed are roots comprising a skin-like composition that forms on said roots or part thereof a continuous layer. This continuous layer can also be used for protecting the roots from viruses and other harmful organisms.

In accordance with yet other examples, there is disclosed a tuber comprising a skin-like composition that forms on said tuber or part thereof a continuous layer. This continuous layer can also be used for protecting the tubers from viruses and other harmful organisms.

In the context of the present disclosure, the term “skin-like composition” is used herein to denote an agriculturally acceptable composition, preferably a biocompatible composition and/or a biodegradable composition, that provides an effect on the plant or any part thereof on which it is applied. The skin-like composition typically forms a layer, optionally is in a form of an elastic layer, such as a film cover over the plant surface onto which it is applied. The cover can provide a single beneficial/functional effect or can be formed of a combination of substances that provide more than one beneficial effect. In some examples, and as described herein, the skin like composition provides a protective film over the surface of the plant onto which it is applied. As also noted herein, the protection can be, for example, from environmental conditions and/or plant pathogens. In addition or alternatively, the skin-like composition can form a film over the surface of the plant onto which it was applied and act as a carrier for active agent.

In some examples, the skin-like composition is in a form of a layer over the surface of the plant onto which it was applied. In some other examples, the skin-like composition is in a form of a continuous layer, at times continuous film cover, over the surface of the plant onto which it was applied. In the context of the present disclosure, a “continuous cover” is used to denote a layer/sheet/patch like structure, as opposed to particulate/powder.

The continuous cover can be defined by the % of the surface of the plant or plant part that it is covering. For example, when the cover is applied onto the plant, the continuity of the cover can be defined by an average covering of at least 60%, at times, at least 70%, at times at least 80%, at times at least 90% of a surface the plant. The surface of the plant in accordance with the disclosure is any of a plant's external, exposed surface onto which the composition can be applied and includes at least part of the plant which is capable of undergoing vegetative reproduction.

In some examples, the skin-like composition is or comprises a carrier matrix. In some examples, the carrier matrix is or comprises a polymeric material. The fact that a matrix is forms allows for any one of the following to take place: the matrix can act as a carrier for active substances/agents; and/or the voids formed within the matrix can render the film with gas permeability (e.g. O₂/CO₂ permeability).

The polymer may be a crosslinked polymer. In some embodiments, the polymeric material is a hydrogel.

The functional cover can also be characterized by any on the following (as also described herein):
Degradability, namely, being able to break down into smaller components, intermediates or end products thereof, as a result of any one or combination of solubilization, hydrolysis, biodegradation (e.g. by biological entities such as bacteria, viruses or enzymes), chemical breakdown, thermal breakdown, as a result of exposure to radiation or any other suitable mechanism which results in the degradation of the coating. The degradability of the cover can be controlled by the addition of substances that either enhance or delay the decomposition of the polymers forming the continuous cover (e.g. the polymeric matrix).
Biocompatibility and lack of phytotoxicity
Transparency, namely, allowing light to pass therethrough without substantially scattering the light or with minimal scattering of the light. In particular, transparency denotes the capability to transfer at least the light rays required for photosynthesis, including at least blue and red light rays and at times also violet light rays.
Thickness and compactness—in order for the cover to accomplish one of its intended purposes, it has to prevent plant pathogens from coming into contact with the plant. In some cases, this is referred to as high compactness features to provide a physical barrier against the pathogen, e.g. virus.

The layer can comprise a single polymer or a combination of polymers.

In some embodiments, the polymer is or comprises a hydrophilic polymer.

In some examples, the layer comprises at least one polysaccharide. The term polysaccharide as used herein includes also modified polysaccharides.

In some examples, the polysaccharides are biodegradable.

There are a variety of polysaccharides and modified polysaccharides (e.g. chemically modified polysaccharides) that can be employed in the context of the present disclosure. At minimum, the polysaccharides are agriculturally acceptable, non-phytotoxic and/or food safe.

In some examples, the polysaccharide is selected from the group consisting of cellulose, chitin, chitosan, starch, amylose, amylopectin, pectin, alginate, gum Arabic, glycogen, any salt, derivative or combination thereof.

In some examples, the polysaccharide is at least one of cellulose, chitin, chitosan, starch, amylose, amylopectin, pectin, alginate, gum Arabic, glycogen, a salt, derivative or combination thereof.

In some examples, the carrier matrix comprises cellulose and/or cellulose derivatives.

In some examples, the at least one polysaccharide is at least one of carboxymethyl cellulose (CMC), methylcellulose (MC), hydroxy propyl cellulose (HPC), hydroxy propyl methylcellulose (HPMC), ethyl cellulose or any salt or derivative thereof.

In some examples, the carrier matrix comprises at least one of CMC, MC or combination thereof.

In some examples, the carrier matrix comprises at least CMC. In some examples, the carrier matrix comprises at least MC.

In some examples, the carrier matrix comprises chitosan and/or derivative thereof.

In some examples, the at least one polysaccharide is at least one of chitosan or carboxymethyl chitosan.

In some examples, the carrier matrix comprises starch (e.g. amylose starch).

In some examples, the carrier matrix comprises pectin.

In some examples, the carrier matrix comprises alginate.

In some examples, the carrier matrix comprises polysaccharide resins such as gum Arabic.

As noted above, the skin-like composition can carry at least one active agent. In the context of the present disclosure, the term “active agent” denotes a chemical or biological molecule or combination of molecules which exhibit a certain effect(s) on the plant or plant part which is brought into contact with such agent. The active agent can act locally (at the point of its application) or at a different location within the plant or the plant part, e.g. after penetration and transported to the different location by the plant's transportation system.

In such embodiments that the skin-like composition comprises an active agent, the composition can protect the active agent from environmental damages, as well as to increase availability of the active agent, for example by reducing/preventing it's migration/escape from at least part of the plant (e.g. by evaporation).

The active agent is not limited to a specific agent and include any agent that is beneficial to the plant, i.e. a growing plant as described herein. The active agent can be a small molecule or mixture thereof, oligomer, macromolecule, polymer, a protein, DNA or RNA.

In some embodiments, the active agent is a biostimulant. A biostimulant as used herein refers to a substance that is capable to stimulate natural processes of plants to benefit their nutrient use efficiency and/or their tolerance to abiotic stress.

In some embodiments, the biostimulant is a non-living substance. In some embodiments, the biostimulant is chemical substance. In some other embodiments, the biostimulant is an organic compound.

In some embodiment, the active agent is at least one of a humic substance, a vitamin, an amino acid, a mineral, a seaweed, a phytohormone or a combination thereof.

In some embodiments, the biostimulant is a humic substance, such as a humic acid or a fulvic acid.

In some other embodiments, the biostimulant is a vitamin, an amino acid, a mineral or a seaweed.

In some other embodiments, the biostimulant is a phytohormone.

In some embodiments, the active agent is capable of controlling plant pests.

The term “plant pest” may be understood in accordance with the definition in terms of the International Plant Protection Convention and phytosanitary measures worldwide and refers to any species, strain or biotype of plant, animal, or pathogenic agent injurious to plants or plant products.

Non-liming examples of plant pests include ectoparasites, oomycetes insects, mites, fungi, bacteria, viruses, virus-like organisms' nematodes, gastropods, protozoa, phytopathogen or phytoplasmas or any other injurious animal to humans, animals or plant varieties including parasitic plants.

In some embodiments, the active agent is a pesticide. A pesticide refers to a chemical agent or a biological agent being capable of killing or discourages pests.

In some examples, the active agent is effective against pests belonging to hemiptera such as heteroptera, auchenorrhyncha, sternorrhyncha or coleorrhyncha.

Non-limiting examples of pests include:

insects and mites such as: Asian longhorned beetle (ALB), Anoplophora glabripennis, cactus moth, Cactoblastis cactorum, cotton pests: boll weevil, Anthonomus grandis, pink bollworm, Pectinophora gossypiella, emerald ash borer, Agrilus planipennis, European grapevine moth, Lobesia botrana, fruit flies, grasshoppers, gypsy moth, Lymantria dispar dispar, imported fire ant, Japanese beetle, Popillia japonica, light brown apple moth (LBAM), Epiphyas postvittana, Mormon cricket, Anabrus simplex, palmetto weevil, Rhynchophorus cruentatus, pine shoot beetle, Tomicus piniperda,pink hibiscus mealybug, Maconellicoccus hirsutus, spotted-wing drosophila, Drosophila suzukii;

nematodes such as: golden nematode, Globodera rostochiensis, pale cyst nematode, Globodera pallida;

Fungi such as ascomycetes such as Fusarium spp. (Fusarium wilt disease), Thielaviopsis spp. (canker rot, black root rot, Thielaviopsis root rot), Verticillium spp., Magnaporthe grisea (rice blast), Sclerotinia sclerotiorum (cottony rot); Basidiomycetes such as Ustilago spp. (smuts), Rhizoctonia spp., Phakospora pachyrhizi (soybean rust), Puccinia spp. (severe rusts of cereals and grasses), Armillaria spp. (honey fungus species, virulent pathogens of trees);

Fungus-like organisms such as Oomycetes such as Pythium spp., Phytophthora spp., Phytomyxea such as Plasmodiophora and Spongospora; Phytoplasmas and spiroplasmas;

Viruses, viroids and virus-like organisms such as aphids, fungi, nematodes, protozoa, beet leafhopper.

In some embodiments, the active agent is at least one of a herbicide, an insecticide, a nematicide, a molluscicide, a piscicide, an avicide, a rodenticide, a bactericide, an insect repellent, an animal repellent, an antimicrobial (bactericide), a fungicide, a virucide or combination thereof.

In some embodiments, the active agent is a bactericide, fungicide, virucide or a combination thereof.

In some examples, the active agent is anti-microbial substance. An anti-microbial agent refers to an agent that kills microorganisms or stops their growth.

In some examples, the active agent is a virucide. A virucide is capable of deactivating or destroying viruses.

For example, the active agent can be one effective against the PVY virus. Further, for example, the active agent can be one active against tuber diseases, e.g. deep or common scab blemish disease, erwinia Pythium root rot, protozoa, etc.

In some examples, the active ingredient is an insecticide, including aphids.

In some examples, the active ingredient is a herbicide.

In some examples, the active agent is an essential oil or a component thereof. In some examples, the essential oil is Tea Tree Oil (TTO), mint oil, thyme oil, oregano oil, eucalyptus oil, cinnamon oil, citral oil, thymol oil or carvacrol oil.

In some examples, the essential oil is TTO or a component thereof.

In some examples, the essential oil is thymol oil or a component thereof.

In some embodiments, the active agent comprises a component derived from at least one essential oil.

In some other embodiments, the active agent is or comprises at least one terpene.

The active agent may be a combination of the active agent with a carrier, the latter facilitating or enhancing the delivery of the active ingredient to its target site within the plant or a plant part. Such carrier may be an emulsion or hosting molecule (such as cyclodextrin) or it can be a complex carrier such as nano-capsule, nanosphere or liposome, where the active ingredient is encapsulated within or entrapped by the complex carrier. The combination of the active ingredient with a carrier can provide a sustained and/or prolonged delivery of the active ingredient to the plant.

In some examples, the active agent (be it a free molecule or a combination of the active molecule with the carrier) is embedded within the polymeric cover, e.g. embedded within the polymeric matrix.

The active agent is distributed homogenously with respect to the polymeric cover. In some cases, the is homogenously dispersed within said polymeric film/matrix. The term “homogenously dispersed” as used herein means that the active agent as described herein appears in the same or very similar concentration in any volume or amount of the polymeric film.

The term “encapsulated” or “embedded” refers to a manner by which at least one active agent is incorporated into a polymeric matrix. Encapsulation include for example homogenous distribution of the at least one active agent throughout the polymeric matrix or homogenous entrapment of the at least one active agent in voids within said matrix. The degree and uniformity of the encapsulation may also be a result of chemical and/or physical interactions between the matrix and the at least one active agent, provided that the active agent is homogenously distributed therein.

In some examples, the skin-like composition comprises at least one acid or a salt thereof. In some examples, the at least one acid or salt thereof is selected from the group consisting of Potassium Sorbate, Citric acid, Acetic Acid, Sorbitan Monooleate (Tween® 80), Stearic Acid.

The present disclosure equally concerns a single plant and a plurality of plants. At times, the plurality of plants are within a nursery (agricultural housing).

Therefore, the present disclosure also provides in accordance with some aspects, a nursery comprising a plurality of plants as disclosed herein, each plant comprises a skin-like composition, wherein the skin-like composition is a carrier matrix in a form of a continuous layer covering at least one surface of said plant, wherein said layer permits at least gas exchange therethrough; and wherein at least part of said plant is capable of undergoing vegetative reproduction.

The nursery in some examples comprises multiple plants in at least one of rooting stage, sprouting stage, seedling stage, vegetative stage, budding stage, flowering stage, ripening stage, reproductive stage, or senescence stage. In some other examples, the nursery comprises multiple vegetative reproduction materials. The vegetative reproduction material is a plant part being at least one of runners, bulbs, tubers, corms, suckers, plantlets, kiekis, apomixis, roots, sprouts, stem, a leaf, cuttings, buds or combination thereof.

The plant or nursery are obtained by performing on the plant method steps that provide the plant or plurality of plants.

Hence, in accordance with some aspects, the present disclosure provides a method for treating a plant, the method comprises applying onto the plant an agriculture formulation in a manner forming a continuous layer on at least one surface of the plant, wherein the agricultural formulation is or comprises a carrier matrix, the continuous layer permits at least gas exchange therethrough and wherein at least part of the plant is capable of undergoing vegetative reproduction.

The method, which also constitutes part of the present disclosure, can be applied onto a single plant or a plurality of plants within a nursery.

It is of note that the continuous layer is formed by application of the agriculture formulation on at least one surface the plant.

The application of the agriculture formulation over at least one surface of the plant provides the plant with a desired effect which is beneficial to the plant or part thereof. As described in the examples below, the skin-like compositions in the form of a continuous layer of the invention formed by application of the agriculture formulation was capable of protecting plants or parts thereof from various environmental conditions as well as from plant pests.

Hence, it is to be understood that in the context of the present disclosure, treatment encompasses the management or care of an already existing condition, as well as a prophylactic (preventative) treatment. The treatment does not necessarily mean an effect on a disease and the type of treatment is dictated by the type of the polymer (e.g. polysaccharide) and/or the active agent applied.

In accordance with some embodiments, the methods of the invention comprise reducing damage to plant.

As such, the present disclosure provides a method for reducing damage to a plant, the method comprises applying onto the plant an agriculture formulation in a manner forming a continuous layer on at least one surface of the plant, wherein the agriculture formulation is or comprises a carrier matrix, wherein the continuous layer permits at least gas exchange therethrough and wherein at least part of the plant is capable of undergoing vegetative reproduction.

Reducing plant damage as used herein refers to an improvement in any plant growth parameter, including, inter alia, improved root growth, improved root size maintenance, improved root effectiveness, increase in plant height, bigger leaf blade, greener leaf color.

The effect of the agriculture formulation and specifically the continuous layer formed by the agriculture formulation can be evaluated for example by comparing plant or a part thereof (e.g. a vegetative reproduction material) which is grown under the same environmental conditions with and without application of the agriculture formulation and hence without the continuous layer. As shown in the Examples below and detailed herein, the continuous layer protected the growth of plant and part thereof.

In some examples, treatment encompasses protecting the plant or a plant part from environmental damage. In some embodiments, the method is for treating or preventing damages to at least part of the plant, capable of undergoing vegetative reproduction. The damages can be caused by environment stress (e.g. lack/reduced light, cold stress, heat stress, water loss, UV). In some embodiments, the methods of the invention comprise treating or preventing damages to at least part of the plant, the damages caused by at least one of lack/reduced light, heating, chilling, amount of water, UV.

In some cases, the treatment is a protective treatment where the agriculture formulation is applied without any active agent and hence the skin-like composition does not comprise an active agent.

In some other cases, the treatment is a protective treatment where the agriculture formulation is applied with at least one active agent and hence the skin-like composition comprises at least one active agent.

In some embodiments, the treatment is a plant growth promoting treatment. In some embodiments, the methods comprise applying the agriculture formulation comprising at least one active agent, the at least one active agent is at least one plant growth promoting agent. In some embodiments, the methods comprises application of a biostimulant. In some examples, the agriculture formulation comprises as an active agent at least one of a plant nutrient, a phytohormone, a vitamin, a mineral or a combination thereof.

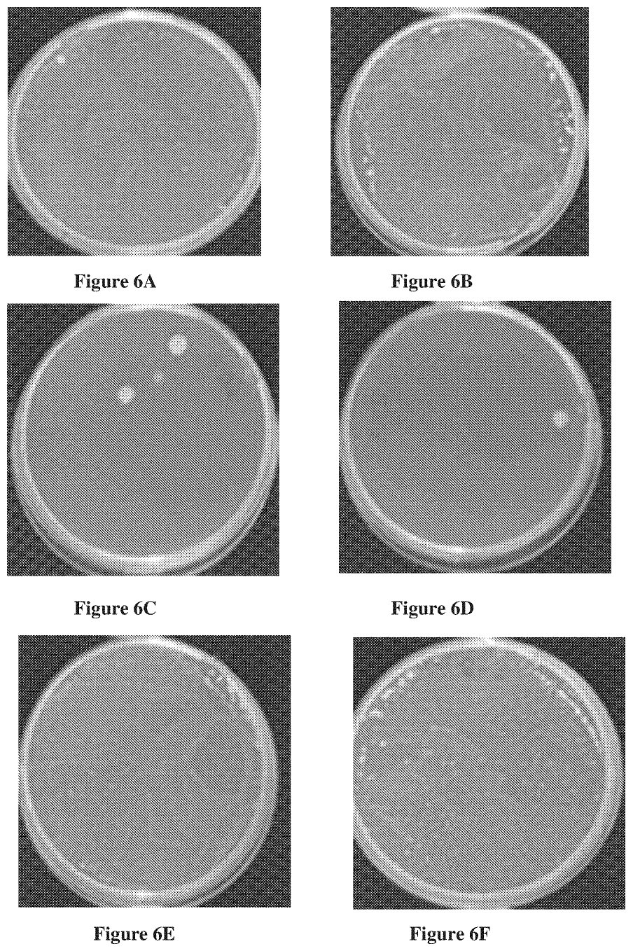

As shown in the Examples below, for example in Example 2, a reduction in the total aerobic count was observed in broccoli sprouts and alfalfa sprouts treated with skin-like compositions comprising chitosan with or without an antimicrobial agent, such as potassium sorbate. Further and as shown in FIGS. 5A-5F and FIGS. 6A-6F, samples from alfalfa sprouts and broccoli sprouts treated with chitosan had less microbial growth. Further, as shown in Example 3, an anti-fungal activity indicated in a reduction of yeast and mold numbers, was observed in Broccoli sprouts and Alfalfa sprouts treated with skin-like compositions comprising chitosan with or without an antimicrobial agent. Also as shown in FIGS. 7A-7F, seedlings treated with carboxymethyl cellulose (CMC) or with chitosan containing potassium sorbate had a better appearance even at sub-optimal conditions, suggesting a protective effect of the compositions.

In some other embodiments, treatment of the plant provides pest control. The term pest control encompasses repelling or killing pests and any variant thereof at all cycle stages, such as eggs etc.

The term “repelling and/or killing” refers to the complete range of positive effects of the formulation and specifically the continuous layer covering at least part of the plant (e.g. a part that is capable of undergoing vegetative reproduction). The term repelling as used herein encompasses prevention of development of symptoms and/or a reduction in the severity of symptoms that will or are expected to develop upon pest's activity on the plant or part thereof. The term killing as used herein refers to ensuring the death of at least part of the pest population.

The term control of pest encompasses eradicating, suppressing, reducing or inhibiting pests activity as well as eliminating part of or a whole pest population.

The term pest population refers to an adult pest population, larval or nymphal population, instar population, egg population, mixed populations, or any combinations thereof. It should be noted that the number of pests in the population may vary from one to several millions. The pest population according with the present disclosure includes all the forms during the pest's life cycle. In addition, the pest population comprise one or more types of pests.

In some examples, the methods of the invention are for repelling or killing at least one pets and/or for treating or preventing any damage that can be caused by at least one pest.

In some examples, the methods of the invention are for repelling or killing at least one of Thrips, Aphid, White-fly, Mite, Mealy-bug, Orius and/or for treating or preventing any damage that can be caused by at least one of Thrips, Aphid, White-fly, Mite, Mealy-bug, orius.

The agriculture formulation and hence the formed continuous layer described herein being non-toxic can be applied to a variety of plants, at all stages as detailed herein.

For example, the agriculture formulation can be applied in at least one vegetative stage and/or at least one seedling stage.

As described herein, the agriculture formulation can be applied on the entire plant (i.e. the entire surface of the plant) or onto at least part of the plant that is capable of undergoing vegetative reproduction. Hence, the amount of the applied agriculture formulation is determined to allow formation of continuous layer as defined herein (the skin-like composition), covering at least 60% of at least one surface of the plant and/or permitting at least gas exchange therethrough.

In some examples, the agriculture formulation comprises also an active agent, of the type described hereinabove. In some cases, the active agent is dissolved, suspended, or emulsified and homogenously distributed within the polysaccharide-based cover matrix.

The agriculture formulation is accordance with some examples is a liquid composition.

The agriculture formulation is accordance with some other examples is in a form of an aerosol.

The agriculture formulation is applied onto the plant by any means known in the art.

In some embodiments, the method comprises applying the agriculture formulation by at least one of spraying, dripping, dipping, brushing, immersing or fog spraying.

In some examples, the method comprises applying the agriculture formulation onto the plant or part thereof by spraying, e.g. using a dedicated humidifier/vaporizer system.

In some examples, the method comprises applying the agriculture formulation onto the plant or part thereof by dipping the plant within the polymeric coating composition.

In some examples, the method comprises applying the agriculture formulation onto the plant or part thereof by smearing it over the plant.

In some embodiments, the agriculture formulation is introduced into a fogger creating fog, optionally an homogenous fog, for example in a nursery (greenhouse).

The agriculture formulation may be administrated at various protocols. As appreciate, an administration protocol can be adjusted based on various factors, including, inter alia, the polymer, the presence or absence of an active agent and the treatment.

In some embodiment, the method comprises applying the agriculture formulation once every few hours or days, e.g. 1 hour to at least 7 days.

In some embodiment, the method comprises multiple applications. The application times and length of interval may depend, for example, on the plant part. In some other embodiments, the method comprises applying the agriculture formulation to a plant and/or plant part for two times, during any stages as detailed herein above or under zany conditions as detailed above, which may be predetermined (e.g. temperature, humidity, UV, pest count) at an interval of about 1 hour, about 5 hours, about 10 hours, about 24 hours, about two days, about 3 days, about 4 days, about 5 days, about 1 week, about 10 days, about two weeks, about three weeks, about 1 month or more. In some other embodiments, the method comprises applying the composition to a plant and/or plant part for more than two times, for example, 3 times, 4 times, 5 times, 6 times, 7 times, 8 times, 9 times, 10 times, or more, during any desired growing stage, at an interval of about 1 hour, about 5 hours, about 10 hours, about 24 hours, about two days, about 3 days, about 4 days, about 5 days, about week, about 10 days, about two weeks, about three weeks, about 1 month or more. The intervals between each application can vary if it is desired.

The present disclosure also encompasses sequential application of various agriculture formulation.

In some examples, the composition comprises one or more polymers as described herein.

In some examples, the agriculture formulation comprises at least about 0.1% w/v polymer.

In some examples, the agriculture formulation comprises between about 0.2% w/v and about 5% w/v of the polymer. In some examples, the agriculture formulation comprises between about 0.4% w/v and about 2.0% w/v of the polymer, at times between about 0.4% w/v and about 1.7% w/v of the polymer.

The polymer in accordance with some embodiments is at least one polysaccharide as described herein. The polysaccharides are dissolved in water or water-based solutions.

The agriculture formulation can be a water-based composition, comprising at least 70% water. In some embodiments, the agriculture formulation is a water based composition comprising at least 75%, at times at least 80%, at times at least 85%, at times at least 90%, at times at least 95%, at times at least 97%, at times at least 98%, at times at least 99%, at times at least 99.5% water. In some embodiments, the agriculture formulation comprises between about 70% and about 99.6% water, at times between about 80% and about 99.6% water, at times between about 85% and about 99.6% water, at times between about 90% and about 99.6% water.

In some examples, the agriculture formulation is an aqueous formulation or a nano emulsion comprising at least one of the following:
(i) alginate, at times at least about 1% alginate, at times about 1% algiante;
(ii) alginate and thymol, at times at least about 1% alginate and at least about 2% thymol, at times about 1% alginate and about 2% thymol;
(iii)alginate and TTO, at times at least about 1% alginate and at least about 2% TTO, at times about 1% alginate and about 2% TTO;
(iv)MC, at times at least about 1% MC, at times about 1% MC;
(v) MC and TTO, at times at least about 1% MC and at least about 2% TTO, at times about 1% MC and about 2% TTO;
(vi)MC and Thymol, at times at least about 1% MC and at least about 2% Thymol, at times about 1% MC and about 2% Thymol;
(vii) CMC, at times at least about 1%, at times at least about 1.5%, at times about 1%, at times about 1.5%;
(viii) CMC and TTO, at times at least about 1% CMC and at least about 1% TTO, at times at least about 1% CMC and at least about 2% TTO, at times about 1% CMC and about 1% TTO, at times about 1% CMC and about 2% TTO;
(ix)CMC and Thymol, at times at least about 1% CMC and at least about 2% Thymol, at times about 1% CMC and about 2% Thymol;
(x) CMC and strearic acid, at times at least about 1% CMC and at least about 0.6% strearic acid, at times about 1% CMC and about 0.6% strearic acid
(xi)Chitosan, at times at least about 1%, at times about 1%;
(xii) Thymol at times at least about 1%, at times at least 2%, at times about 1%, at times about 2%;
(xiii) TTO at times at least about 1%, at times at least 2%, at times about 1%, at times about 2%;
(xiv) Chitosan and TTO, at times at least about 1% chitosan and at least about 2% TTO, at times about 1% chitosan and about 2% TTO;
(xv) Chitosan and Thymol, at times at least about 1% chitosan and at least about 2% Thymol, at times about 1% chitosan and about 2% Thymol;
(xvi) Chitosan, TTO and acetic acid, at times at least about 1% chitosan, at least about 1% TTO and at least about 0.4% (w/v) acetic acid, at times about 1% chitosan, about 1% TTO and about 0.4% (w/v) acetic acid;
(xvii) Chitosan, and acetic acid, at times at least about 1% chitosan, and at least about 0.4% (w/v) acetic acid, at times about 1% chitosan, and about 0.4% (w/v) acetic acid, at times about 1.2% chitosan, and about 0.6% (w/v) acetic acid;
(xviii) Chitosan, acetic acid and potassium sorbate, at times at least about 1% chitosan, at least about 0.4% (w/v) acetic acid and at least 0.1% potassium sorbate, at times about 1.2% chitosan, about 0.6% (w/v) acetic acid and 0.1% potassium sorbate;
(xix) CMC and potassium sorbate, at times at least about 1.5% CMC and at least about 0.1% of potassium sorbate, at times about 1.5% CMC and about 0.1% of potassium sorbate;
(xx) potassium sorbate, at times at least about 0.1%, at times about 0.1%.

Exemplary agriculture formulations are provided in Table 4 below, which forms part of the invention. The agriculture formulations of the invention such as those detailed herein above and/or in Table 4 can be in an aqueous form or a nano emulsion. Further, the agriculture formulations of the invention such as those detailed herein above and/or in Table 4 can comprise at least one active agent as described herein.

At times where the composition comprises an active agent, it was suggested that application of the formulation may be effective via various profiles including a rapid release followed by a sustained/slow/delayed release or only a sustained/slow/delayed release, providing a prolong effect/activity of the formulation (i.e. the active agent). In accordance with such embodiments, the formulation comprises an effective amount of at least one active agent.

The term “effective amount” as used herein may be determined by conditions/tests/experiments known to a skilled person in the art. The amount is sufficient to treat a plant or part thereof (e.g. a vegetative reproduction material) as described herein.

As used herein, the forms “a”, “an” and “the” include singular as well as plural references unless the context clearly dictates otherwise. For example, the term “active agent” includes one or more active molecules or substances which are capable of affecting the condition of the growing plant.

Further, as used herein, the term “comprising” is intended to mean that the composition include the recited components, e.g. active ingredients, but not excluding other elements, such as agriculturally acceptable excipients as well as other active ingredients. The term “consisting essentially of” is used to define components which include the recited elements but exclude other elements that may have an essential significance on the condition of the plant. “Consisting of” shall thus mean excluding more than trace elements of other elements. Embodiments defined by each of these transition terms are within the scope of this invention.

The term “about” as used herein indicates values that may deviate up to 1%, more specifically 5%, more specifically 10%, more specifically 15%, and in some cases up to 20% higher or lower than the value referred to, the deviation range including integer values, and, if applicable, non-integer values as well, constituting a continuous range. As used herein the term “about” refers to ±10%.

The invention will now be exemplified in the following description of experiments that were carried out in accordance with the invention. It is to be understood that these examples are intended to be in the nature of illustration rather than of limitation. Obviously, many modifications and variations of these examples are possible in light of the above teaching. It is therefore, to be understood that within the scope of the present disclosure, the invention may be practiced otherwise, in a myriad of possible ways, than as specifically described hereinbelow.

### Detailed Description of Embodiments

The following non-limiting examples, exhibit a solution to a need for skin-like composition of plants at their growth stages, such us germination, seedling, vegetative, reproduction, and senescence materials and on the whole plants so as to improve, inter alia, yield and quality of the plant or the harvested material therefrom.

### Materials and Methods

Carboxymethyl cellulose (CMC) sodium salt and Methyl cellulose (MC) were purchased from Alfa Aesar (Heysham, LA32XY, England).

Chitosan (molecular weight-1526.464 g/mole) was purchased from Molekula (Newcastle upon Tyne, UK).

Alginic acid sodium salt was purchased from Sigma Aldrich.

Sorbitan monooleate (Tween® 80) and Stearic Acid (StA) were purchased from Sigma-Aldrich (St. Louis, Mo., USA).

Acetic acid was purchased from Holland Moran.

Ethanol was purchased from Merck.

Cold-pressed organic sunflower oil (Joe & Co, Italy) was purchased at organic supermarket.

Thymol 99% (MW 150.22) was purchased from Holland Moran (Acros organics). Australian tea tree oil (TTO) was purchased from pure oil (Tamar distribution).

Echo-tech from “Hishtil” LTD.

Seedlings and cuttings were obtained from “Hishtil” Ltd.

### EXAMPLE 1: The Phytotoxicity Effect of the Carrier-Matrix Based Polysaccharide on Sprouts of Alfalfa and Broccoli

Broccoli and alfalfa sprouts were divided into six groups and each group was coated by immersion into the following compositions and observed after 6 days:
(1) 1.5% (w/v) aqueous solution of carboxymethyl cellulose (CMC) that contain 0.1% (w/v) of potassium sorbate.
(2) 1.2% (w/v) aqueous solution of chitosan with 0.6% (w/v) acetic acid that contain 0.1% (w/v) of potassium sorbate.
(3) 1.5% (w/v) aqueous solution of CMC.
(4) 1.2% (w/v) aqueous solution of chitosan with 0.6% acetic acid.
(5) An aqueous solution of 0.1% (w/v) of potassium sorbate.
(6) Control, no treatment.

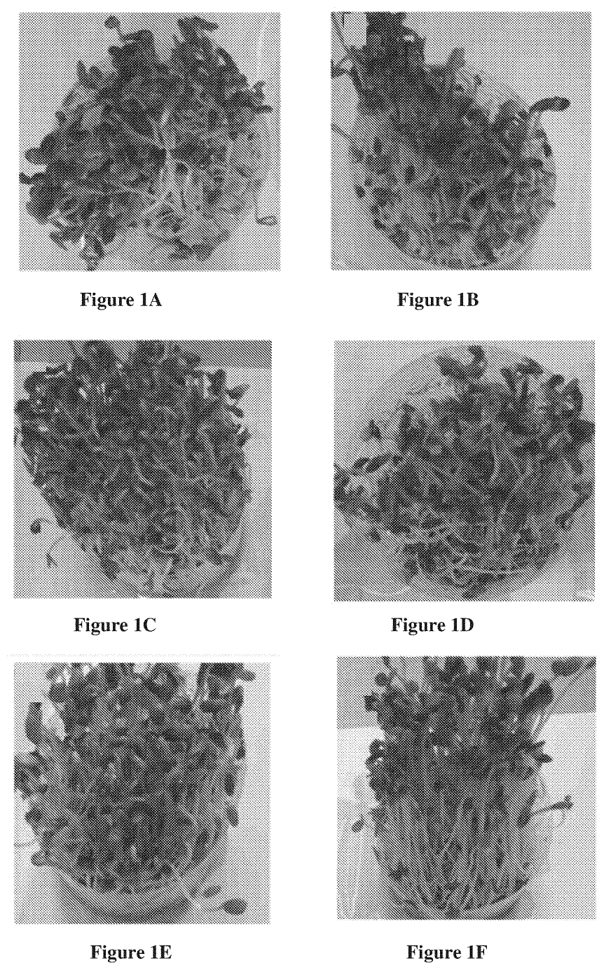

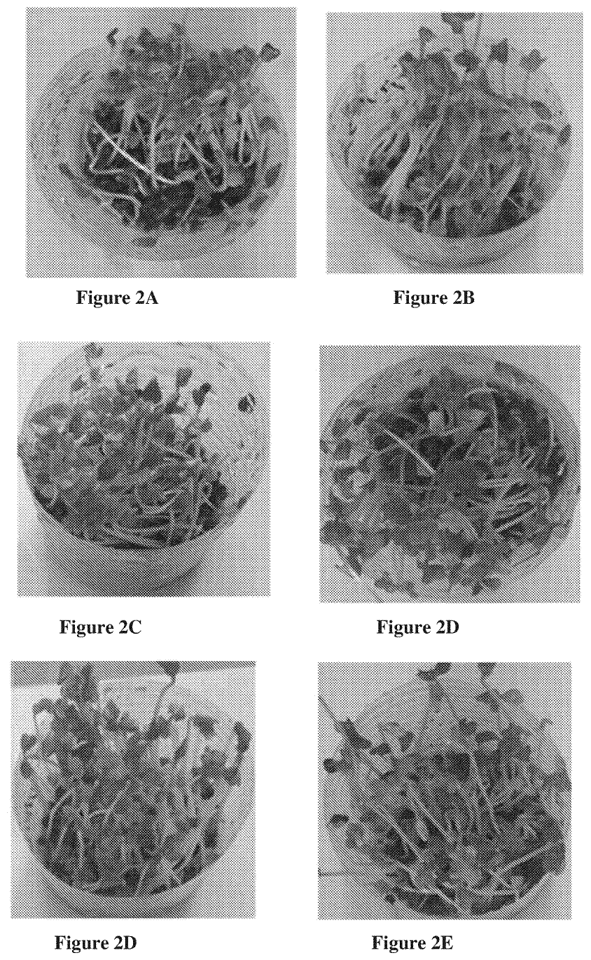

The results of the six days observations are shown in FIGS. 1A-1F and 2A-2F. As shown in these figures, alfalfa (FIGS. 1A-1E) and broccoli (FIGS. 2A-2E) sprouts treated with compositions 1 to 5 as detailed above, had no phytotoxicity signs compared to the control group sprouts without any treatment (FIGS. 1F and 2F respectively).

### EXAMPLE 2: The Anti-Microbial Effect of the Carrier-Matrix Based Polysaccharide on Sprouts of Alfalfa and Broccoli

The effect of the carrier-matrix compositions on microbial content was examined by CFU counting on Plate Count Agar (PCA) and potato dextrose agar supplemented with 100 ppm of antibiotic, chloramphenicol, (PDA+A).

For each type of plant five groups of sprouts were divided into 5 groups and treated as followed:
(1) An aqueous solution of 0.1% (w/v) of antimicrobial agent potassium sorbate.
(2) 1.5% (w/v) aqueous solution of carboxymethyl cellulose (CMC) that contain 0.1% (w/v) of antimicrobial agent potassium sorbate.
(3) 1.2% (w/v) aqueous solution of chitosan with 0.6% (w/v) acetic acid that contain 0.1% (w/v) of antimicrobial agent potassium sorbate.
(4) 1.5% (w/v) aqueous solution of CMC.
(5) 1.2% (w/v) aqueous solution of chitosan with 0.6% acetic acid.

Examples were incubated overnight at 20° C. Then, 5 g of the sprouts were aseptically inserted into a stomacher bags and diluted 10-fold with sterile distilled water. The samples were placed in a laboratory stomacher (Seward 400 stomacher; Mier science technology Ltd) and homogenized for 1 min at 260 rpm to detach microbes from the sprouts. From each beaker, 10-fold serial dilution of the liquid suspension was done. Microbial load was determined by plating 100 μL on PCA plates and PDA+A plates followed by incubation at 30° C. for 24 h and 48 h to assess total aerobic count and yeast & molds count respectively.

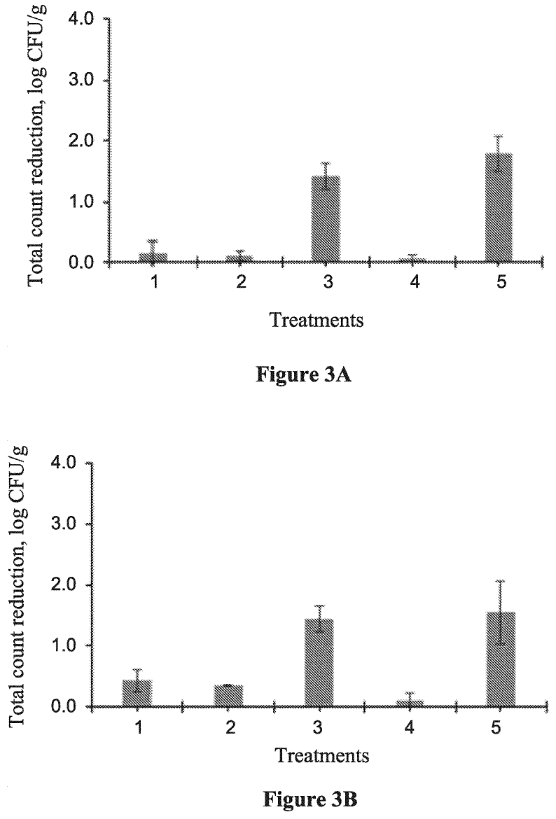

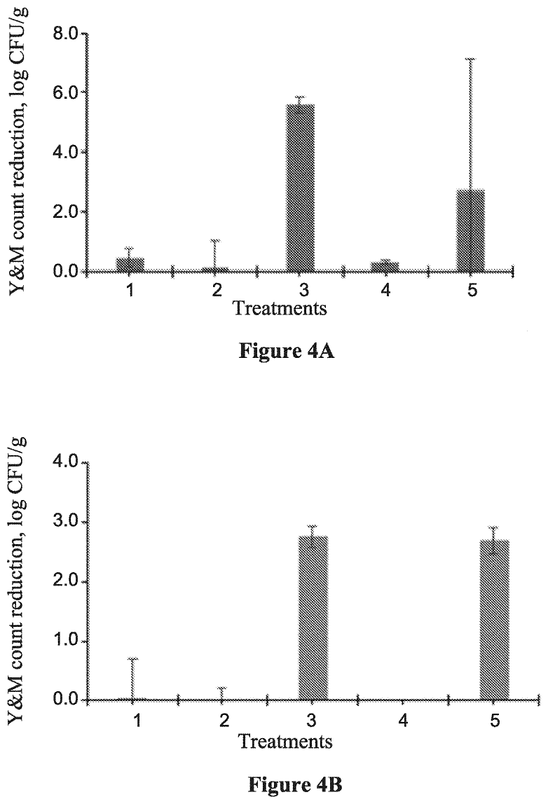

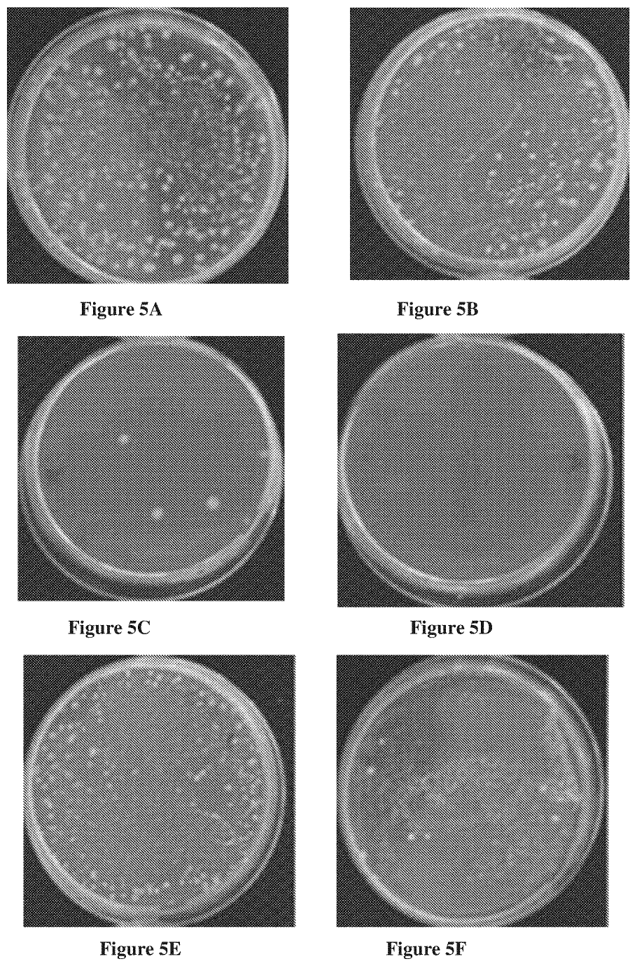

The results of the effect of compositions 1-5 on microbial content are presented in FIG. 3A (Broccoli) and 3B (Alfalfa). Specifically, FIGS. 3A-3B show a ˜1.5-2.0 log reduction in the total aerobic count for the example of Broccoli and Alfalfa sprouts treated with aqueous solution of 1.2% (w/v) chitosan with 0.6% acetic acid (#5) or aqueous solution of 1.2% (w/v) chitosan with 0.6% (w/v) acetic acid that contain 0.1% (w/v) of potassium sorbate (#3) normalized to control.

### EXAMPLE 3: The Anti Fungal Effect of the Carrier-Matrix Based Polysaccharide on Sprouts of Alfalfa and Broccoli

The anti-fungal effect of the compositions detailed in Example 2 was examined by an antifungal assay (PDA+A) The 5 g of the sprouts were aseptically inserted into a stomacher bags and diluted 10-fold with sterile distilled water. The samples were placed in a laboratory stomacher (Seward 400 stomacher; Mier science technology Ltd) and homogenized for 1 min at 260 rpm to detach microbes from the sprouts. From each beaker, 10-fold serial dilution of the liquid suspension was done. Microbial load was determined by plating 100 μL on PDA+A plates followed by incubation at 30° C. for 48 h to assess yeast & molds count. The results are presented in FIGS. 4A and 4B. Treatment with chitosan alone (#5) or chitosan-potassium sorbate mixture (#3) demonstrated highest inhibitory activity, normalized to the control, a about 2.5-6.0 log reduction of yeast and mold numbers on broccoli (FIG. 4A) and about 2.5-3.0 log reduction on alfalfa (FIG. 4B). A much higher efficacy was evident with the antifungal assay compared with the microbial assay.

FIGS. 5A-5F and FIGS. 6A-6F show that samples from Alfalfa sprouts treated with chitosan had less microbial growth (FIGS. 5C and 5D) in comparison to other treated sprouts. The same effect was shown with Broccoli, as evident from FIGS. 6C and 6D.

### EXAMPLE 4: The Cytotoxicity and Phenotypic Effects/Durability and Shelf-Life of Carrier-Matrix Based Polysaccharide on Broccoli Plant Seedlings

The cytotoxicity and phenotypic effects of carrier-matrix compositions were examined on Purple Broccoli plant seedlings. Six groups of seedlings were treated with compositions as detailed below:
(1) An aqueous solution of 1.5% (w/v) carboxymethyl cellulose (CMC).
(2) An aqueous solution of 1.5% (w/v) carboxymethyl cellulose (CMC) that contain 0.1% (w/v) of potassium sorbate.
(3) An aqueous solution of 1.2% (w/v) chitosan with 0.6% (w/v) acetic acid.
(4) An aqueous solution of chitosan 1.2% (w/v) with 0.6% (w/v) acetic acid that contain 0.1% (w/v) of potassium sorbate.
(5) An aqueous solution of 0.1% (w/v) of potassium sorbate.
(6) No treatment, a control.

The foliage (leaf) seedling treatment was performed by immersion the leaves in the treatment for 30 second and then repotted in the soil. The treatment of the seedling groups was followed by an observation for 7 days. The seedlings were grown during the first 3 days (from the treatment) under optimal condition that included normal sun exposure for 8 hours in September (summertime) and watering with 60 ml of water every day. From the fourth day, the seedlings growth conditions changed to sub-optimal conditions (dark room and no watering).

After 3 days of optimal growth conditions no deterioration was observed in any of the treated groups. Neither a cytotoxic effect nor a significant change in plant quality.

The phenotypic appearance observations are summarized in Table 1. The table shows the scores of the phenotypic appearance of the seedlings, based on color of the leaf, wilting, stem firmness, stem length; where (1) denotes the worst phenotypic appearance where the plant is wilting and 5 denotes the best phenotypic appearance.

TABLE 1
The growth effect of the carrier-matrix compositions on Purple
Broccoli plant seedlings under sub-optimal conditions.

| | Treatment Group | | | | | |
|---|---|---|---|---|---|---|
| | (1) | (2) | (3) | (4) | (5) | (6) |
| Stem length | 0.3 | −0.3 | −0.5 | 0 | −0.5 | −0.6 |
| change (cm) | | | | | | |
| Appearance | 4.5 | 3 | 1 | 4.5 | 2 | 1 |
| scoring* | | | | | | |
| Related FIG. | FIG. 7A | FIG. 7B | FIG. 7C | FIG. 7D | FIG. 7E | FIG. 7F |

*Each value indicates the means of 4 duplicate tests.

Table 1 shows that under the sub-optimal conditions plants that were treated with carboxymethyl cellulose alone (treatment 1) or with chitosan that includes potassium sorbate (treatment 4) had the best appearance score. Specifically, the leaf color stayed green-purple and there was no wilting in these two seedlings groups. In addition, the stems were stable and their length did not reduce (as opposite to the other treatments) and even increased in the example treated with CMC composition (treatment 1).

FIGS. 7A-7F provide images of the seedlings of the treatment groups (1) to (6), respectively. It can be clearly seen that plants that were treated with carboxymethyl cellulose (treatment 1) or with chitosan containing potassium sorbate (treatment 4) had in general a better appearance.

### EXAMPLE 5: Preparation of a Carrier-Matrix Based Polysaccharide Comprising Essential Oil

The carrier-matrix based 1% (w/v) of polysaccharide solutions were made as followed:

1% (w/v) of Chitosan and 0.4% (w/v) of acetic acid solution: 1 gr of chitosan powder was dissolved in 100 ml sterilized water that included 0.4% of acetic acid upon stirring at room temperature to obtain a 1% (w/v) solution.

1% (w/v) of Carboxymethyl cellulose (CMC) solution: 1 gr of CMC sodium salt powder was dissolved in 100 ml sterilized water upon stirring at 80° C. for one hour to obtain a 1% (w/v) solution.

1% (w/v) of Methyl cellulose (MC) solution: 1 gr of MC powder was dissolved in 100 ml sterilized water upon stirring at 70° C. for one hour to obtain a 1% (w/v) solution to obtain a 1% (w/v) solution.

1% of Alginic acid solution: 1 gr of Alginic acid sodium salt powder was dissolved in 100 ml sterilized water upon stirring for one hour to obtain a 1% (w/v) solution.

1% (w/v) of CMC and 0.6% (w/v) of stearic acid solution: 1% of CMC solution was prepared as described above. Stearic acid was dissolved in 33.3 ml ethanol, that included Sorbitan monooleate TWEEN 80 (0.1% v/v) stirring on a hot plate at 70° C. for one hour. Then the CMC and stearic acid solutions were mixed to a total volume of 50 ml and homogenized for five minutes to obtain a solution of 1% CMC (w/v) and 0.6% (w/v) of stearic acid.

For the preparation of the nano-emulsions of the carrier-matrix based polysaccharide comprising essential oil, two steps were performed. At the first step nano-emulsions of essential oil were prepared as detailed hereinbelow.
(1) A mixture of Thymol with sunflower oil at a 1:3 ratio was poured into Tween 80 and double-distilled water (DDW) and stirred for one hour, resulted with a Thymol emulsion.
(2) A mixture of Tea Tree oil (TTO) with sunflower oil at a 1:1 ratio was poured into Tween 80 (1%) and double-distilled water (DDW) and stirred for 30 min resulted with a TTO emulsion.

Then each emulsion was homogenized for 1 min at power control 5 using a power control unit homogenizer (Kinematica, Luzern,Switzerland). Followed by a nano-emulsification using ultra-sonicator (Sonics &amp; MaterialsInc., Newtown, Conn., USA) at 70% intensity, 20 kHz (frequency) and 400 W (nominalpower input) for 15 minutes.

At the second step, for the carrier-matrix based methyl cellulose (MC) solutions, the nano-emulsified thymol\tea tree oil was dissolved with methyl cellulose (MC) powder and stirred at 70° C. to obtain a 2% (v/v) Thymol\Tea Tree oil (2 gr of thymol\TTO and 1 gr of tween 80 in 100 ml distilled water) and 1% MC nano-emulsion (w/v) (1 gr of methyl cellulose powder in 100 ml distilled water). For the carrier-matrix based Alginate solutions, the nano-emulsified Thymol\Tea Tree was dissolved with alginic acid sodium salt powder and stirred to obtain a 2% (v/v) thymol\tea tree oil (2 gr of thymol\TTO and 1 gr of tween 80 in 100 ml distilled water) and 1% Alginate nano-emulsion (w/v) (1 gr of alginic acid salt powder in 100 ml distilled water).

### EXAMPLE 6: The Cytotoxicity Effect of Carrier-Matrix Nano-Emulsions on Tomato Seedlings

The cytotoxicity effect of carrier-matrix nano-emulsions on Tomato seedlings was examined Tomato seedlings were divided into two groups that differ at their immersion site. In the first group the foliage (leaf) was treated and in the second group the roots were treated. For each group six treatments were examined. The treatments are described hereinbelow:
(1) A nano-emulsion based on 1% (w/v) Tea Tree oil.
(2) A nano-emulsion based on 1% (w/v) Tea Tree oil and aqueous solution of 1% (w/v) chitosan with 0.4% (w/v) acetic acid.
(3) A nano-emulsion based on 1% (w/v) Tea Tree oil and aqueous solution of 1% (w/v) carboxymethyl cellulose.
(4) A solution based on 1% (w/v) aqueous solution chitosan with 0.4% (w/v) acetic acid.
(5) A solution based on 1% (w/v) aqueous solution of carboxymethyl cellulose.
(6) Control, no treatment.

The experiment included 3 seedling replicates for each group. The seedlings were stored at a greenhouse at 24° C. and humidity of 70% for one week. The root seedling treatment was performed by immersion the roots in the treatment nano-emulsion/solution for 5 min and then repotted in the soil. The foliage (leaf) seedling treatment was performed by immersion the leaves in the treatment nano-emulsion/solution for 30 seconds and then repotted in the soil. The control samples were immersed in sterile, distilled water.

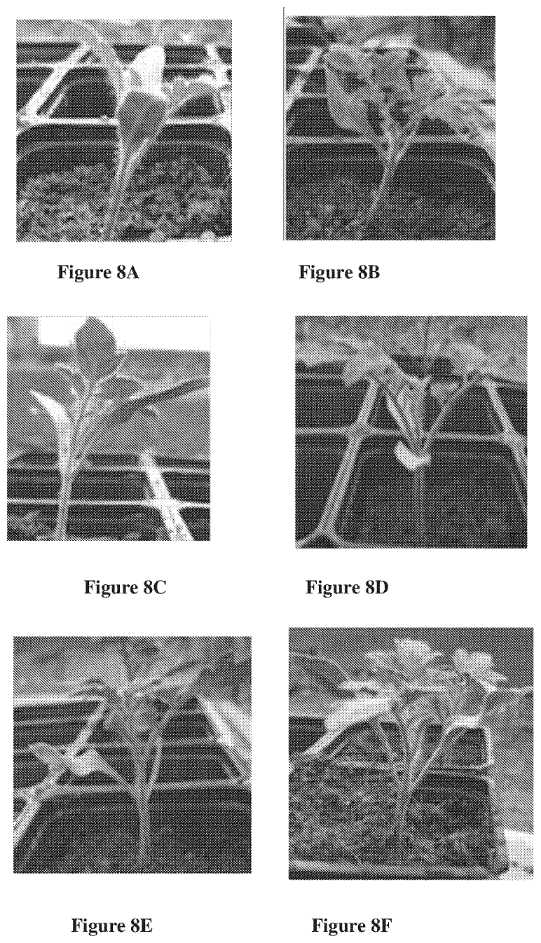

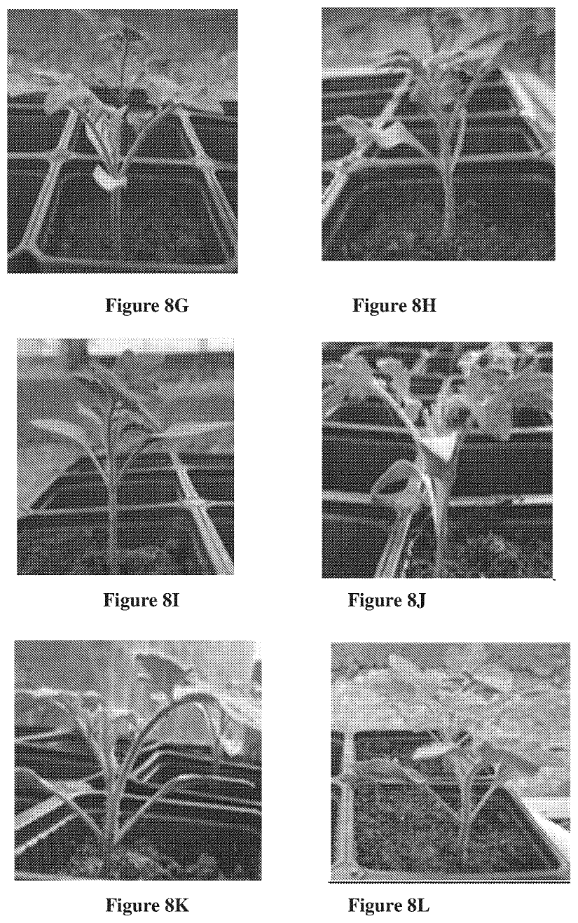

After 7 days, the seedlings were photographed as shown in FIGS. 8A-8L, which should be considered together with Table 2. For all treated samples of roots and leaf, no cytotoxic effect was observed.

TABLE 2
treatmnt result in FIGS. 8A-8L

| | Treatment Group | | | | | |
|---|---|---|---|---|---|---|
| | (1) | (2) | (3) | (4) | (5) | (6) |
| Roots | FIG. 8A | FIG. 8B | FIG. 8C | FIG. 8D | FIG. 8E | FIG. 8F |
| Leaf | FIG. 8G | FIG. 8H | FIG. 8I | FIG. 8J | FIG. 8K | FIG. 8L |

### EXAMPLE 7: Permeability and Contact Angle Characterization of the Carrier-Matrix Compositions

The permeability of different carrier-matrix compositions was examined by water vapor permeability (WVP) test. Test tube containing 10 ml of distilled water was covered with a film sample resulted from the carrier-matrix solution/nano-emulsion. Film forming solutions were cast on plastic Petri dishes (50 mm diameter) and allowed to dry at 25° C. for 24 h in a chemical hood. For comparison, control films of 1% (w/v) aqueous solution of CMC and Chitosan without TTO were produced.

The samples were sealed with carbon tape to prevent leakage. Then were stored at the desiccator and maintained in 25° C. for 24 h and 96 h to ensure complete saturation of the film samples. The weight difference of the test tube before and after 24 h was determined based on the following equation

$$\frac{Δ W \cdot L}{Δ A \cdot Δ P \cdot t}$$

ΔW−weight difference of the crucibles (g), L is the film thickness (m), A is the filmarea (m²), ΔP is the vapor pressure difference (3,170 Pa at 25° C.) and t is the permeation time (s).

The results are summarized in Table 3.

TABLE 3
The water vapor permeability of
carrier-matrix compositions

| Treatment Group | WVP |
|---|---|
| Chitosan and Tea Tree oil | 0.31 |
| Chitosan | 0.75 |
| Carboxymethyl Cellulose (CMC) and TTO | 0.46 |
| CMC | 0.24 |

As can be seen in Table 3, comparison between film samples based on Chitosan shows that the permeability decreases when adding TTO. On the other hand, comparison between the film samples based on CMC shows that adding TTO increases the permeability. Films with minimal WVP reduce the water transport through the leaves/preserved food and thereby increase its shelf life.

### Water Contact Angle

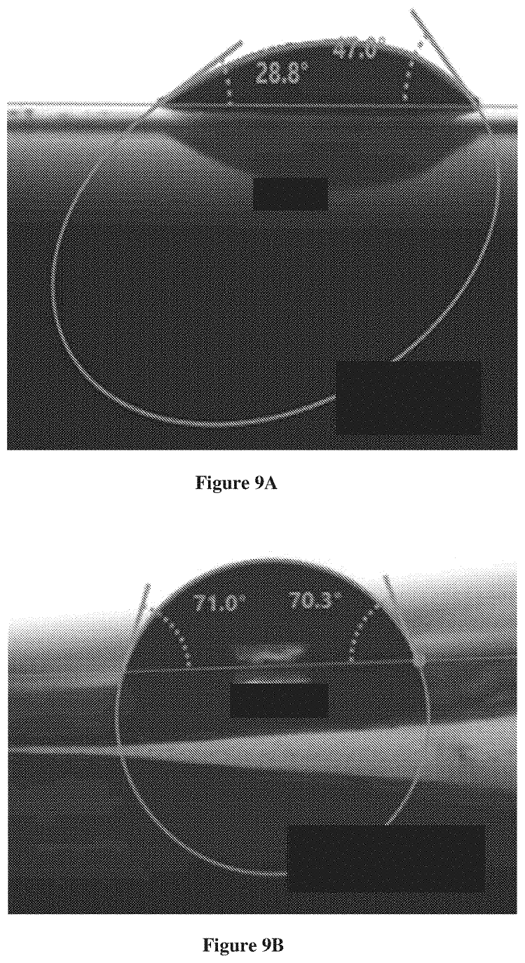

In addition the contact angel of samples based Chitosan were examined Samples of leaf treated with carrier-matrix based chitosan as detailed in Table 3 (2 cm×2 cm) were used for determining water contact angle by a goniometer. Specifically, distilled water drops (5 μl) were placed on the surface of each sample of a leaf and the static contact angle of the water droplet on the surface was measured Small contact angles (<<90°) correspond to high hydrophilicity, while large contact angles (>>90°) correspond to high hydrophobicity. FIGS. 9A-9B show that the carrier-matrix based Chitosan and TTO composition has a larger angel compared to the Chitosan alone sample and therefore is more hydrophobic.

### EXAMPLE 8: The Cytotoxicity and Phenotypic Effects/Durability and Shelf-Life and Growth Development Effect of Carrier-Matrix Based Polysaccharide with Essential Oil on Mint, Salvia and Rosemary Cuttings

The cytotoxicity and phenotypic effects/durability and shelf-life of carrier-matrix based polysaccharide with essential oil were examined on mint, salvia and rosemary cuttings. Bags of cuttings were prepared as described below. The contents of each bag of cuttings were scattered on the conveyor belt at the entrance to spraying cell. The spray is in the form of a mist, at a flow rate of 50-100 cm cubic per minute. Drop size 50-70-micron. The duration time in the spraying cell is 40 seconds on the upper conveyor belt and 20 seconds on the lower conveyor belt. The coverage density is 2400-3500 per square centimeter. After spraying, the cuttings were placed on a tray covered with absorbent paper for two minutes to dry and then packed back in bags and stored in cold room (6° C.) for 48 hours (simulating a standard export condition). The Rooting capabilities were examined at “Hishtil LTD” in Afula. The carrier-matrix based on two polysaccharides alginate 1% and methyl cellulose 1% (MC) with the active agents, thymol and tea tree oil (TTO) 2%.

For the preparation of the nano-emulsions of the carrier-matrix based polysaccharide comprising essential oil, two steps were performed. At the first step nano-emulsions of essential oil were prepared as detailed below.

Thymol: A mixture of Thymol with sunflower oil at a 1:3 ratio was poured into Tween 80 and double-distilled water (DDW) and stirred for one hour, resulted with a Thymol emulsion. Tea Tree oil: A mixture of Tea Tree oil (TTO) with sunflower oil at a 1:1 ratio was poured into Tween 80 (1%) and double-distilled water (DDW) and stirred for 30 min resulted with a TTO emulsion.

Then each emulsion was homogenized for 1 min at power control 5 using a power control unit homogenizer (Kinematica, Luzern,Switzerland). Followed by a nano-emulsification using ultra-sonicator (Sonics &amp; MaterialsInc., Newtown, Conn., USA) at 70% intensity, 20 kHz (frequency) and 400 W (nominalpower input) for 15 minutes.

At the second step, for the carrier-matrix based methyl cellulose (MC) solutions, the nano-emulsified thymol/tea tree oil was dissolved with methyl cellulose (MC) powder and stirred at 70° C. to obtain a 2% (v/v) Thymol/Tea Tree oil (2 gr of thymol/TTO and 1 gr of tween 80 in 100 ml distilled water) and 1% MC nano-emulsion (w/v) (1 gr of methyl cellulose powder in 100 ml distilled water). For the carrier-matrix based Alginate solutions, the nano-emulsified Thymol/Tea Tree was dissolved with alginic acid sodium salt powder and stirred to obtain a 2% (v/v) thymol\tea tree oil (2 gr of thymol/TTO and 1 gr of tween 80 in 100 ml distilled water) and 1% Alginate nano-emulsion (w/v) (1 gr of alginic acid salt powder in 100 ml distilled water).

Eight treatments were examined—(i) Alg (1%) and Thymol (2%), (ii) Alg (1%) and TTO (2%), (iii) MC (1%) and Thymol (2%), (iv) MC (1%) and TTO (2%), (v) Thymol (2%) alone, (vi) TTO (2%) alone, (vii) MC (1%), (viii) Alg (1%). The model plants are mint, rosemary, sage and thyme. Each treatment included 100 units of the same type of cutting between treatments the spraying system rinsed with water.

The different carrier-matrix compositions comprising Thymol or Tea Tree oil, were applied on various types of cuttings such as mint, salvia and rosemary to examine their effect on cuttings storability. The treated cuttings were stored at 6° C. and the measurements were taken after 24 h (regular storage time), 48h (prolonged storage time) 4 days and 7 days (the extremely prolonged storage). FIGS. 10A-10E demonstrates the cuttings after 7 days of storage and show that cuttings treated with the carrier-matrix compositions were more storability. As can be seen, the treated plants kept their quality, while the untreated control samples show significant deterioration, especially at mint and salvia cuttings. Further the growth development effect of the carrier-matrix compositions on cuttings was examined. The treated cuttings were stored for 48 hours at 6° C., and then transferred to greenhouse to examine their rooting ability after the treatment, while the untreated cuttings were used as control.

The carrier-matrix based on two polysaccharides alginate 1% and methyl cellulose 1% (MC) with the active agents, thymol and tea tree oil (TTO) 2%. For the preparation of the nano-emulsions of the carrier-matrix based polysaccharide comprising essential oil, two steps were performed. At the first step nano-emulsions of essential oil were prepared as detailed hereinbelow.

For the preparation of the nano-emulsions of the carrier-matrix based polysaccharide comprising essential oil, two steps were performed as described above.

FIG. 11A-B show that the root system of sage plants after 17 days of growth demonstrates a good rooting ability and proper plant development.

### EXAMPLE 9: The Pesticide Effect of Carrier-Matrix Based Polysaccharide with Essential Oil on Mint, Salvia and Rosemary Seedlings

The ability of carrier-matrix based polysaccharide with essential oil such as Thymol and Tea Tree oil (TTO) to protect the plants from harmful organisms such as Thrips, Aphid, White-fly, Mite, Mealy-bug and orius insects was examined 153 trays of rosemary, mint, thyme were transferred to the incubator for pest control. 13 days after exposure to pests, dozens of pests—thrips, leaf aphids and mites populate each tray. Each tray is divided into 3 sections of 6 rows (60 seedlings), in all treatments—Alginate (1% w/v in water), Alginate (1% w/v)+TTO (2% v/v) in water, Alginate (1% w/v)+Thymol (2% w/v) in water, MC (1% w/v) in water, MC (1% w/v)+TTO (2% v/v) in water, MC (1% w/v)+Thymol (2% w/v) in water, Control- water, Eco-tech (0.1% w/v) in water- positive control. The seedlings were sprayed in the 6-meter-long spray tunnel, conveyor speed was 0.75 meters per second, spray volume 200 cc per minute, droplet size 50-70 microns. Pest inspection was done 18 hours after the spraying.

Then the carrier-matrix composition was applied on seedlings of mint, thyme and rosemary. The treated seedlings were inoculated with insects for 12 days and stored at the insect's greenhouse. After 12 days the infected seedlings were sprayed with the treatments and stored for 24 hours at ambient temperature and humidity. Examined occur after 18 hours. Water treatment was used as a negative control and the currently used highly effective Eco-tech treatment was used as positive control.

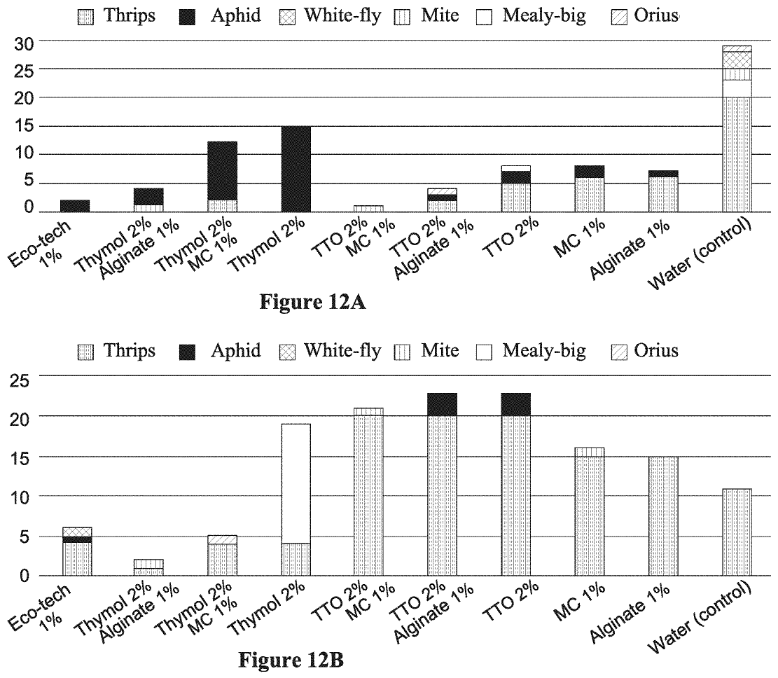

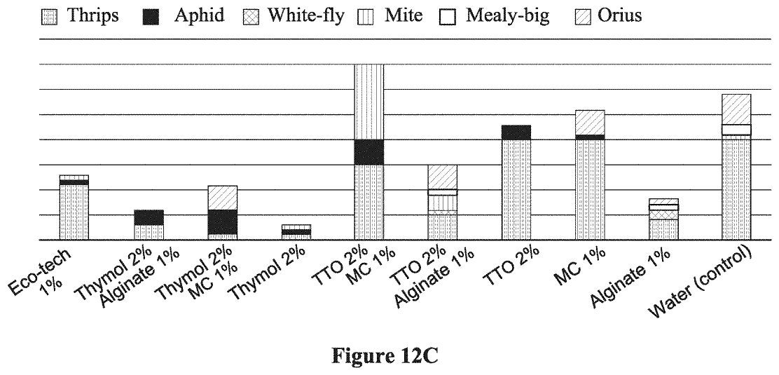

FIG. 12A-12C show results of live pests obtained 18 hours after spraying with various compositions on mint, rosemary, thyme, respectively, that show that the carrier-matrix based on MC (1%) with TTO (2%) demonstrated the best pesticide effect. Moreover it can be seen that seedlings treated with the polymers Alg (1%)+Thymol (2%) and MC (1%)+Thymol (2%) showed significant decrease in number of insects relative to the control group.

### EXAMPLE 10: The Phytotoxicity Effect of the Carrier-Matrix Based Polysaccharide with Essential Oil on Rosemary, Thyme, and Mint Seedlings

The carrier-matrix based on polysaccharides alginate 1% with the active agent, thymol 2%. At the first step nano-emulsions of essential oil were prepared as detailed hereinbelow. A mixture of Thymol with sunflower oil at a 1:3 ratio was poured into Tween 80 and double-distilled water (DDW) and stirred for one hour, resulted with a Thymol emulsion. Then emulsion was homogenized for 1 min at power control 5 using a power control unit homogenizer (Kinematica, Luzern,Switzerland). Followed by a nano-emulsification using ultra-sonicator (Sonics &amp; Materialslnc., Newtown, Conn., USA) at 70% intensity, 20 kHz (frequency) and 400 W (nominalpower input) for 15 minutes.

At the second step, alginic acid sodium salt powder was dissolved and stirred to obtain a 2% (v/v) thymol\ (2 gr of thymol and 1 gr of tween 80 in 100 ml distilled water) and 1% Alginate nano-emulsion (w/v) (1 gr of alginic acid salt powder in 100 ml distilled water).

The phytotoxicity effect of carrier-matrix based polysaccharide with essential oil on rosemary, thyme and mint seedlings was examined Two samples of each type of plant were treated by directly applying the following compositions, carrier-matrix based alginate (1%) with Thymol (2%), and Thymol (2%) alone. After treatment, the seedlings were stored at 24° C. for 24 hours. Significant phytotoxicity was observed at all type of seedlings, mint, rosemary and thyme upon direct application of thymol alone. No phytotoxicity was observed upon treatment with carrier-matrix based Alginate with Thymol.

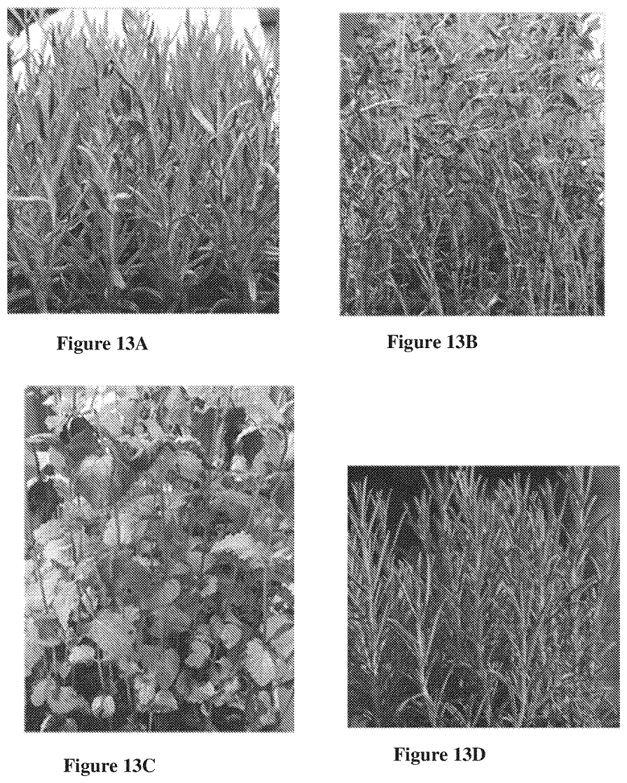

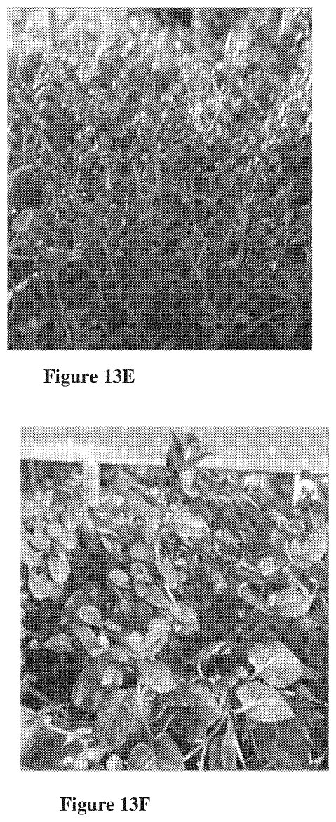

FIGS. 13A-13F show photos of rosemary, thyme and mint plants after treated with carrier-matrix based alginate with Thymol, and with Thymol alone.

### EXAMPLE 11: Size Characterization of Carrier-Matrix Compositions

Physicochemical characterizations of the active envelopes were performed by dynamic light scattering (DLS) Zetasizer Nano ZS laser diffractometer (Malvern Instruments Ltd, Worcestershire, UK) and nikon eclipse ti2 microscope. The results of the DLS indicate that carrier-matrix based Alginate with the essential oils causes a significant increase in particle size compared to essentials oils alone. These results of these measurements are consistent with the results of the microscope, it is noticeable that the carrier-matrix based Alginate creates structures around the active agents and thus increases the size of the particles. However, the carrier-matrix based methyl cellulose creates small structures which reconcile with the idea that it decreases the particle size.

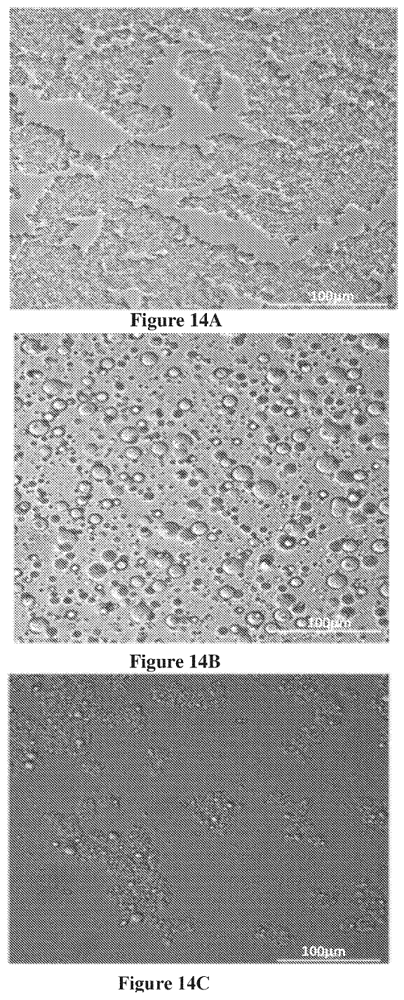

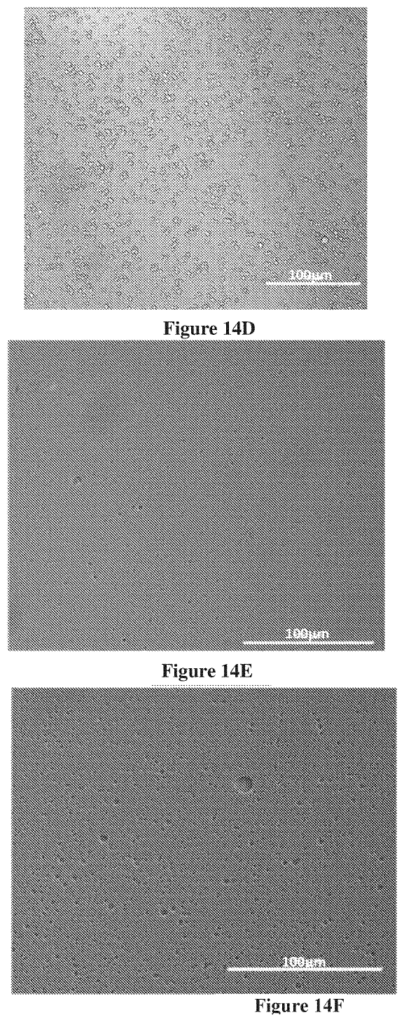

FIGS. 14A-14F show microscope images of different carrier-matrix compositions; 15A carrier-matrix based on Alginate 1% and tea tree oil (TTO) 2%, 15B carrier-matrix based on methyl cellulose (MC) 1% and TTO 2%,15C carrier-matrix based on Alginate 1% and Thymol 2%, 15D carrier-matrix based on MC 1% and Thymol 2%, 15E TTO 2% without polymer matrix, 15F Thymol 2% without polymer matrix The results indicate that alginate creates complexes around the active agent which reconcile with the DLS results. MC creates small structure which reconcile with the DLS results.

### EXAMPLE 12: The Prolonged Release of Thymol from Carrier-Matrix Based Polysaccharide

Release studies of active agent Thymol (2%) from carrier-matrix based alginate (1%) composition 1 gr of alginic acid salt powder, 2 gr of thymol and 1 gr of tween 80 in 100 ml distilled water at 24° C. and 30° C. were performed by Shimadzu Gas Chromatograph GC-2010 Plus equipped with Autosampler-Gerstel MPS Multipurpose sampler. Head space vials stored, open capped, in temperature-controlled rooms: 24° C. or 30° C. The vials were periodically sealed, taken out of the temperature-controlled rooms and examined on a Shimadzu (Japan) gas chromatograph GC 2010, equipped with a head space auto sampler (MPS, Gerstel, USA). Samples were agitated at a temperature of 150° C. for 10 min and then 2500 μL of atmosphere was drawn from the vials into a syringe at 150° C. and 1000 μL injected into the GC. The starting GC oven temperature was 80° C., followed by a temperature increase rate of 7° C./min to a temperature of 180° C., then increase rate of 45° C./min to a temperature of 280° C. holding for an additional 8.5 min.

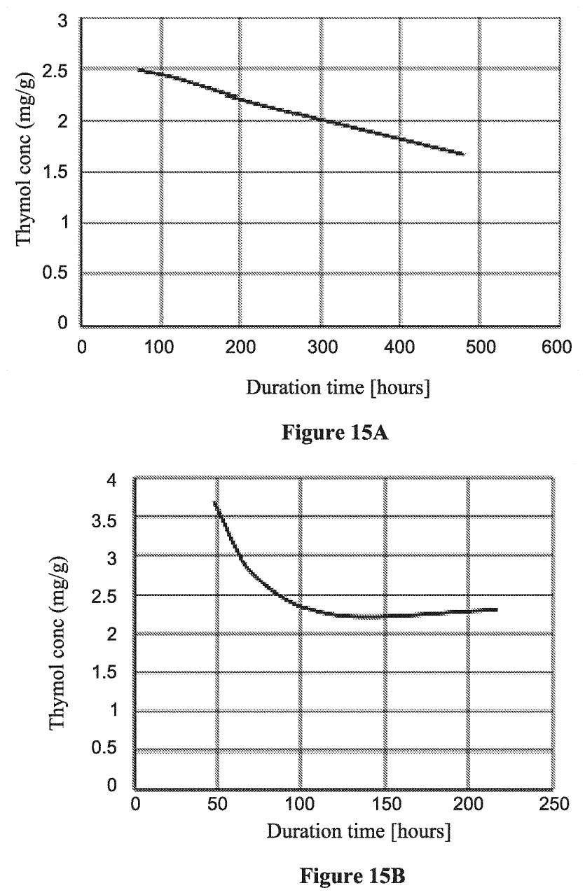

FIGS. 15A-5B show graphs of concentrations of Thymol versus time at 30° C. and at 24° C.

### EXAMPLE 13: Distribution Characterization of the Carrier-Matrix Based Polysaccharide

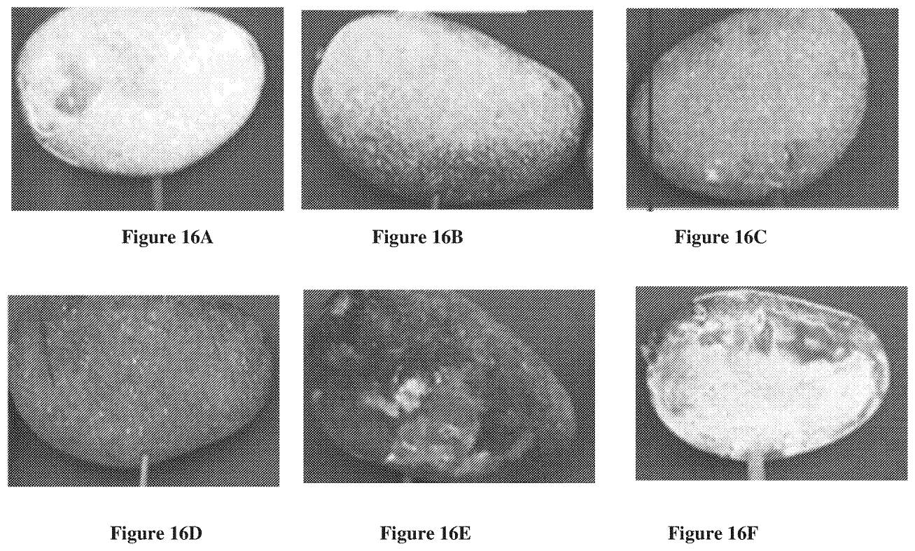

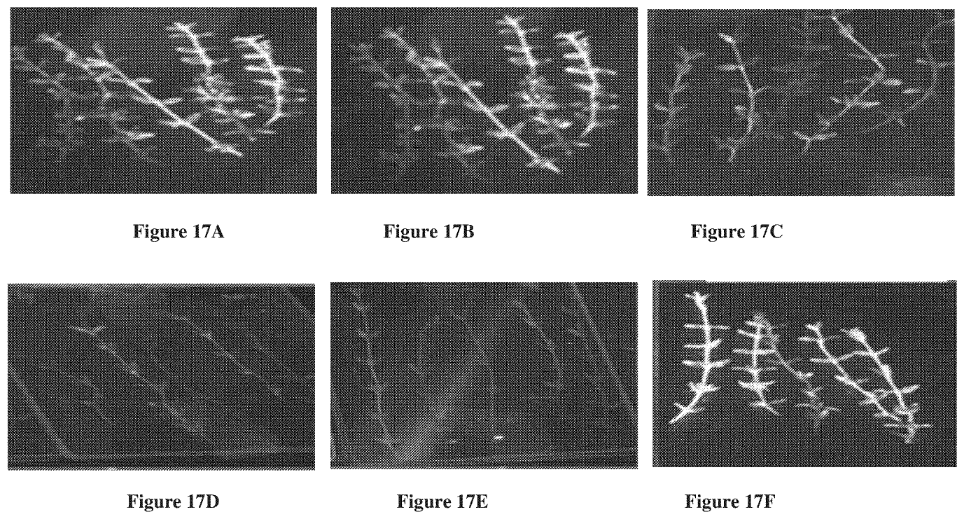

The carrier-matrix based polysaccharide compositions were labeled with fluorescent dye (Lunar yellow at 1% concentration) and were applied by “fog spraying method” on cuttings and potato tuber. The photos were taken when the potato tubers where placed under UV light. FIGS. 16A-16F and FIGS. 17A-17F show images of polysaccharide-based compositions labeled with fluorescent dye (by Lunar yellow at 1% concentration) applied by spraying on potato tuber and on thyme cuttings, respectively. The compositions applied are detailed hereinafter: carrier-matrix based Alginate, carrier-matrix based methyl cellulose MC (1%,), carrier-matrix based carboxymethyl cellulose (CMC1%), carrier-matrix based CMC (1%), and strearic acid(0.6%), carrier-matrix based Chitosan (1%). Also control samples with no treatment only labeled with fluorescent dyelt. It can be seen that alginate and MC-base matrices are the most compatible with the “fog spraying method” resulting in perfectly homogenous cover., to illustrate a continuous polymeric film and the importance of suitable polysaccharide matrix.

TABLE 4
Exemplary formulations comprising at least the following

| No. | Composition |
|---|---|
| 1 | 1% algiante |
| 2 | 1% alginate and 2% thymol |
| 3 | 1% alginate and about 2% TTO |
| 4 | 1% MC |
| 5 | 1% MC and about 2% TTO; |
| 6 | 1% MC and about 2% Thymol |
| 7 | 1% CMC |
| 8 | 1.5% CMC |
| 9 | 1% CMC and about 1% TTO |
| 10 | 1% CMC and about 2% TTO |
| 11 | 1% CMC and about 2% Thymol |
| 12 | 1% CMC and about 0.6% strearic acid |
| 13 | 1% Chitosan |
| 14 | 1% Tymol |
| 15 | 2% Tymol |
| 16 | 1% TTO |
| 17 | 2% TTO |
| 18 | 1% chitosan and about 2% TTO; |
| 19 | 1% chitosan and about 2% Thymol; |
| 20 | 1% chitosan, about 1% TTO and about |
| | 0.4% (w/v) acetic acid; |
| 21 | 1% chitosan, and 0.4% (w/v) acetic acid |
| 22 | 1.2% chitosan, and 0.6% (w/v) acetic acid; |
| 23 | 1.2% chitosan, about 0.6% (w/v) acetic acid |
| | and 0.1% potassium sorbate; |
| 24 | 1.5% CMC and about 0.1% of potassium sorbate; |

1-58. (canceled)

59. A plant comprising a skin-like composition, wherein said skin-like composition is a carrier matrix in a form of a continuous layer covering at least one surface of said plant, wherein said layer permits at least gas exchange therethrough; and wherein at least part of said plant is capable of undergoing vegetative reproduction.

60. The plant of claim 59, wherein said plant is in at least one of rooting stage, sprouting stage, seedling stage, vegetative stage, budding stage, flowering stage, ripening stage, reproductive stage, or senescence stage.

61. The plant of claim 59, wherein said plant is (i) a plant crop, optionally wherein said plant crop is at least one of a fruit plant, a vegetable plant, a herb plant, a cereal plant, or a flowering plant, (ii) a seedling, or (iii) a sprout.

62. The plant of claim 59, wherein said plant part is at least one of a runner, a bulb, a tuber, a corm, a sucker, a plantlet, a kiekies, an apomixis, a leaf, a root, a sprout, a stem, a cutting, a bud or combination thereof.

63. The plant of claim 59, wherein said carrier matrix (i) comprises a polymeric material, (ii) comprises at least one polysaccharide, optionally wherein said at least one polysaccharide is selected from the group consisting of cellulose, chitin, chitosan, starch, amylose, amylopectin, pectin, alginate, gum Arabic, glycogen, and any salt, derivative and combination thereof (iii) is cellulose, carboxymethyl cellulose (CMC), methylcellulose (MC), hydroxy propyl cellulose (HPC), hydroxy propyl methylcellulose (HPMC), ethyl cellulose or any salt or derivative thereof (iv) is chitosan, carboxymethyl chitosan or any salt or derivative thereof, or (v) is alginate or any salt or derivative thereof.

64. The plant of claim 59, wherein said skin like composition comprises at least one active agent.

65. The plant of claim 64, wherein said active agent is a biostimulant

66. The plant of claim 65, wherein said biostimulant is at least one of a humic substance, a vitamin, an amino acid, a mineral, a seaweed, a phytohormone or a combination thereof.

67. The plant of claim 64, wherein said active agent is a pesticide.

68. The plant of claim 67, wherein the active agent is at least one of a herbicide, an insecticide, a nematicide, a molluscicide, a piscicide, an avicide, a rodenticide, a bactericide, an insect repellent, an animal repellent, an antimicrobial (bactericide), a fungicide, a virucide or combination thereof.

69. The plant of claim 64, wherein said active agent is an essential oil or a component thereof.

70. The plant of claim 69, wherein the essential oil is at least one of Tea Tree Oil (TTO), mint oil, thyme oil, oregano oil, eucalyptus oil, cinnamon oil, citral oil, thymol oil, carvacrol oil or combination thereof.

71. The plant of claim 64, wherein said active agent is essentially homogenously dispersed within the continuous layer.

72. The plant of claim 59, wherein said continuous layer covers at least 60% of said at least one surface of said plant.

73. A nursery comprising a plurality of plants, each plant comprises a skin-like composition, wherein said skin-like composition is a carrier matrix in a form of a continuous layer covering at least one surface of said plant, wherein said layer permits at least gas exchange therethrough; and wherein at least part of said plant is capable of undergoing vegetative reproduction.

74. The nursery of claim 73, wherein said plant is in at least one of rooting stage, sprouting stage, seedling stage, vegetative stage, budding stage, flowering stage, ripening stage, reproductive stage, or senescence stage.

75. A method for treating a plant, said method comprises applying onto said plant an agriculture formulation in a manner forming on at least one surface of said plant a continuous layer, wherein said agriculture formulation is or comprises a carrier matrix, the amount of said agriculture formulation is such to permit at least gas exchange therethrough, wherein at least part of said plant is capable of undergoing vegetative reproduction.

76. The method of claim 75, comprising applying said agriculture formulation by at least one of spraying, dipping, brushing, immersing or fog spraying.

77. The method of claim 75, comprising applying said agriculture formulation provides a cover on at least 60% of said at least one surface of said plant.

78. The method of claim 75, wherein said agriculture formulation comprises at least 0.2% w/v polymeric material optionally wherein said polymeric material comprises at least one polysaccharide.
